(19) United States
(12) Patent Application Publication
(10) Pub. No.: US 2018/0162110 A1
(43) Pub. Date: Jun. 14, 2018

(54) METHOD AND APPARATUS FOR PRODUCING FUNCTIONAL FILM

(71) Applicant: FUJIFILM Corporation, Tokyo (JP)

(72) Inventor: Satoshi KUNIYASU, Kanagawa (JP)

(73) Assignee: FUJIFILM Corporation, Tokyo (JP)

(21) Appl. No.: 15/890,870

(22) Filed: Feb. 7, 2018

Related U.S. Application Data
(63) Continuation of application No. PCT/JP2016/070298, filed on Jul. 8, 2016.

(30) Foreign Application Priority Data
Aug. 11, 2015 (JP) 2015-158627

(51) Int. Cl. B32B 37/00; B32B 38/00; B32B 37/15

(52) U.S. Cl. CPC B32B 37/025; B32B 2457/202; B32B 37/153; B32B 38/0008

(57) ABSTRACT

Provided are a method and an apparatus for producing a film with a coating solution including a material whose performance is deteriorated by oxygen functional film, without performance deterioration. The apparatus for producing a functional film includes a coating device which has a backup roller and a die coater and applies a coating solution having a dissolved oxygen concentration of 1000 ppm or less and including 10000 ppm or less of an organic solvent to a flexible support transported in a state where the support is wound around the backup roller to form a coated film, a lamination device which laminates a coated surface of the coated film and the film on the backup roller, and an inert gas atmosphere forming device which forms an inert gas atmosphere in a space including the coated surface from a coating start position to a lamination start position on the backup roller.

### CROSS-REFERENCE TO RELATED APPLICATIONS

This application is a Continuation of PCT International Application No. PCT/JP2016/070298 filed on Jul. 8, 2016, which claims priority under 35 U.S.C. § 119(a) to Japanese Patent Application No. 2015-158627 filed on Aug. 11, 2015. Each of the above applications is hereby expressly incorporated by reference, in their entirety, into the present application.

### BACKGROUND OF THE INVENTION

### 1. Field of the Invention

The present invention relates to a method and an apparatus for producing a functional film, and particularly relates to a technique of producing a functional film with a coating solution that includes a material whose performance is deteriorated by oxygen and does not substantially include an organic solvent.

### 2. Description of the Related Art

A functional film having a specific function is produced by forming a coated film by applying a coating solution including a material having functionality such as optical properties or the like to a flexible support.

However, among materials having functionality, there is a material whose functionality is deteriorated by oxygen and this material causes a problem in the production of a functional film.

As the material whose performance is deteriorated by oxygen, for example, there is a quantum dot (also referred to as a QD particle or a quantum point) used as a light emitting material for a flat panel display such as a liquid crystal display (LCD) (hereinafter, also referred to as LCD).

In the flat panel display market, improvement in color reproducibility has progressed as improvement of LCD performance. Regarding this point, in recent years, a quantum dot (also referred to as a QD particle or a quantum point) has attracted attention as a light emission material. For example, in a case where exciting light is incident on a wavelength conversion member including a quantum dot from a backlight, the quantum dot is excited and emits fluorescent light. Here, in a case of using quantum dots having different light emission properties, white light can be realized by emitting light having a narrow half-width of red light, green light, and blue light. Since the fluorescent light by the quantum dots has a narrow half-width, wavelengths can be properly selected to thereby allow the white light to be designed so that the white light is high in brightness and excellent in color reproducibility.

Due to the progress of such a three-wavelength light source technique using quantum dots, the color reproduction range has been widened from 72% to 100%° in terms of current television (TV) standards (Full High Definition (FHD)) and National Television System Committee (NTSC) ratio.

However, the quantum yield of the quantum dot is deteriorated by oxygen and water vapor, and thus as a countermeasure against this problem, a film having gas barrier properties is laminated on a coating that is formed on a flexible support by coating (quantum dot-containing layer) to protect the film from oxygen and water vapor.

In JP2013-544018A, there is proposed a laminated film formed by laminating a quantum dot-containing layer and gas barrier films having high oxygen barrier properties and water vapor barrier properties in such a manner that both surfaces of the quantum dot-containing layer are interposed between the gas barrier films in order to protect a quantum dot from oxygen and water vapor.

### SUMMARY OF THE INVENTION

However, even in a film formed by laminating a quantum dot-containing layer and gas barrier films having high oxygen barrier properties and water vapor barrier properties such that both surfaces of the quantum dot-containing layer are interposed between the gas barrier films, in a case where protection against oxygen in the production process is not sufficient, there is a problem of causing performance deterioration of a functional film due to oxygen.

This problem is not limited to the quantum dot and also arises in the production of a functional film using a coating solution including a material whose performance is deteriorated by oxygen.

The present invention is made in consideration of the above circumstances, and an object thereof is to provide a method and an apparatus for producing a functional film capable of producing a functional film without performance deterioration in a case where a film is produced with a coating solution including a material whose performance is deteriorated by oxygen.

In order to achieve the object, according to the present invention, there is provided a method for producing a functional film comprising: a coating step of supplying a coating solution having a dissolved oxygen concentration of 1000 ppm or less and including 10000 ppm or less of an organic solvent to a die coater having a backup roller and applying the coating solution to a flexible support which is transported in a state in which the support is wound around the backup roller to form a coated film; and a lamination step of laminating a coated surface of the coated film and a film on the backup roller, in which an inert gas atmosphere is formed in a space including the coated surface from a coating start position to a lamination start position on the backup roller.

According to the method for producing a functional film of the present invention, in the coating step, a coating solution having a dissolved oxygen concentration of 1000 ppm or less and including 10000 ppm or less of an organic solvent is supplied to a die coater having a backup roller, and is applied to a flexible support which is transported in a state in which the support is wound around the backup roller to form a coated film.

That is, a low dissolved oxygen concentration coating solution having a dissolved oxygen concentration of 1000 ppm or less is supplied to an extrusion coating type die coater including a manifold and a slit and is applied to a flexible support which is transported in a state in which the support is wound around the backup roller. Thus, compared to other coating devices such as a gravure coater and a roll coater, a chance of contact between the coating solution and external air (oxygen in external air) can effectively be reduced.

The dissolved oxygen concentration of the coating solution before being supplied to the die coater is more preferably 500 ppm or less and particularly preferably 100 ppm or less.

Since the amount of the organic solvent is 10000 ppm or less and a drying step of drying the coated film formed by coating is not required, it is possible to avoid contact between a coating and external air in a drying step.

In the lamination step, a coated surface of the coated film and the film are laminated on the backup roller. Then, an inert gas atmosphere is formed in a space including the coated surface from a coating start position to a lamination start position on the backup roller.

That is, since the lamination step is performed on the backup roller on which the coating step is performed, a transport distance of the coated film from the coating start position to the lamination start position can be shortened. In addition, since a surface of the coated film close to the flexible support is supported by the backup roller and contact with external air is avoided, an inert gas atmosphere may be formed on only the coated surface.

In the above configuration, since the volume of the space including the coated surface from the coating start position to the lamination start position can be reduced as much as possible, it is possible to efficiently and effectively form an inert gas atmosphere in the space with a small amount of inert gas and to reduce an inert gas concentration distribution in the space.

According to the method for producing a functional film of the present invention, in a case where a film is produced with a coating solution including a material whose performance is deteriorated by oxygen, it is possible to produce a functional film without performance deterioration.

In the method for producing a functional film of the present invention, it is preferable that the inert gas atmosphere is formed by supplying an inert gas into a cover member that covers the space.

As described above, since the volume of the space including the coated surface from the coating start position to the lamination start position can be reduced as much as possible, it is possible to reduce the size of the cover member that covers the space. Accordingly, in a case where an inert gas is supplied into the cover member, it is possible to efficiently and effectively form an inert gas atmosphere in the space with a small amount of inert gas and to reduce an inert gas concentration distribution in the space.

In the method for producing a functional film of the present invention, it is preferable that the inert gas atmosphere is formed by arranging a die block, which has a distal end surface opposite to a surface of the backup roller and a slit which discharges an inert gas from the distal end surface in a width direction of the coated surface, adjacent to a downstream side of the die coater as seen from a transport direction of the flexible support, and discharging the inert gas from the die block to the coated surface.

According to the present invention, by arranging a die block, which has a distal end surface opposite to a surface of the backup roller and a slit which discharges an inert gas from the distal end surface in a width direction of the coated surface, adjacent to a downstream side of the die coater as seen from a transport direction of the flexible support, a thin layer space is formed between the distal end surface of the die block and the coated surface in the transport direction of the coated film. Accordingly, by discharging an inert gas from the die block to the coated surface, the discharged inert gas flows in the thin layer space from the coating start position to the lamination start position accompanied with transport of the coated film and thus forms an inert gas layer on the coated surface.

In the above configuration, in a die block type, compared to a cover member type, it is possible to efficiently and effectively form an inert gas atmosphere in the space with a smaller amount of inert gas and to reduce an inert gas concentration distribution in the space. For example, in the die block type, the oxygen concentration in the space can be set to 100 ppm or less with a small amount of inert gas (for example, about 50 L/min/m) and the discharged inert gas forms an inert gas layer on the coated surface. Thus, the effect of further suppressing generation of an oxygen concentration distribution on the coated surface is exhibited.

It is more preferable to adopt both a cover member type and a die block type.

In the method for producing a functional film of the present invention, it is preferable that a gap of the slit of the die block is 0.1 to 2.0 mm and the inert gas is discharged from the slit in a discharge amount of 20 to 500 L/min/m.

Herein, the unit “m” of the discharge amount means a unit per 1 m width of the flexible support.

Accordingly, since an inert gas atmosphere can be formed by the inert gas discharged from the die block without causing fluctuation or disturbance by waves on the coated surface, evenness in coating thickness related to the performance of a functional film is satisfactory.

In the method for producing a functional film of the present invention, a curing step of irradiating the coated surface with an actinic ray to cure the coated surface is performed on the backup roller after the lamination step.

By performing the curing step on the backup roller on which the coating step and the lamination step are performed as described above, while maintaining a state in which the coated film is supported by the backup roller without being slackened, the coated surface is irradiated with an actinic ray. Thus, a functional film to be produced can be prevented from being wrinkled and the performance of the functional film can be further improved.

In order to achieve the above object, according to the present invention, there is provided an apparatus for producing a functional film comprising: a coating device which has a backup roller and a die coater and applies a coating solution to a flexible support which is transported in a state in which the support is wound around the backup roller to form a coated film; a lamination device which laminates a coated surface of the coated film and a film on the backup roller; and an inert gas atmosphere forming device which forms an inert gas atmosphere in a space including the coated surface from a coating start position to a lamination start position on the backup roller.

According to the apparatus for producing a functional film of the present invention, in a case where a film is produced with a coating solution including a material whose performance is deteriorated by oxygen, it is possible to produce a functional film without performance deterioration.

In the apparatus for producing a functional film according to the present invention, it is preferable that the inert gas atmosphere forming device has a cover member which covers the space, and inert gas supply means for supplying an inert gas into the cover member.

It is preferable that the inert gas atmosphere forming device is a die block which is disposed adjacent to a downstream side of the die coater as seen from a transport direction of the flexible support, and has a distal end surface opposite to a surface of the backup roller, and a slit which discharges an inert gas from the distal end surface in a width direction of the coated surface.

It is preferable that a gap of the slit of the die block is 0.1 to 2.0 mm and the inert gas is discharged from the slit in a discharge amount of 20 to 500 L/min/m.

It is preferable that curing means for irradiating the coated surface with an actinic ray to cure the coated surface is arranged at a downstream position of the lamination device on the backup roller.

The apparatus for producing a functional film according to the present invention and preferable aspects thereof are inventions for apparatus configurations for the method for producing a functional film according to the present invention and the preferable aspects thereof, and in a case where a film is produced with a coating solution including a material whose performance is deteriorated by oxygen, it is possible to produce a functional film without performance deterioration.

According to the present invention, in a case where a film is produced with a coating solution including a material whose performance is deteriorated by oxygen, it is possible to provide a method and an apparatus for producing a functional film capable of producing a functional film without performance deterioration.

### BRIEF DESCRIPTION OF THE DRAWINGS

FIG. 1 is a view showing the overall configuration of an apparatus for producing a functional film according to the present invention.

FIG. 2 is a perspective view showing a main part of an apparatus for producing a functional film using a die block type inert gas atmosphere forming device.

FIG. 3 is an illustration for illustrating an action of the die block type inert gas atmosphere forming device.

FIG. 4 is an illustration of a cover member type inert gas atmosphere forming device.

FIG. 5 is an enlarged view of a lamination portion.

FIG. 6 is a table diagram of Example A.

FIG. 7 is a table diagram of Example B.

FIG. 8A is a view showing a shape of a slit nozzle in Example B.

FIG. 8B is a view showing an arrangement position of the slit nozzle in Example B.

FIG. 9A is a view showing a shape of a bored nozzle in Example B.

FIG. 9B is a view showing an arrangement position of the bored nozzle.

### DESCRIPTION OF THE PREFERRED EMBODIMENTS

Hereinafter, a method and apparatus for producing a functional film according to the present invention will be described with reference to the accompanying drawings in detail.

The present invention is a technique of producing a functional film with a coating solution including a material whose performance is deteriorated by oxygen, and the material whose performance is deteriorated by oxygen will be described in the example of producing a functional film having an optical functional layer as a wavelength conversion member with a coating solution including a quantum dot.

However, the present invention is not limited to the quantum dot and can be applied to all methods for production of a functional film using a coating solution including a material whose performance is deteriorated by oxygen.

In the specification, any numerical range expressed herein using “to” refers to a range including the numerical values before and after the “to”, as the upper limit and the lower limit, respectively.

[Apparatus for Producing Functional Film]

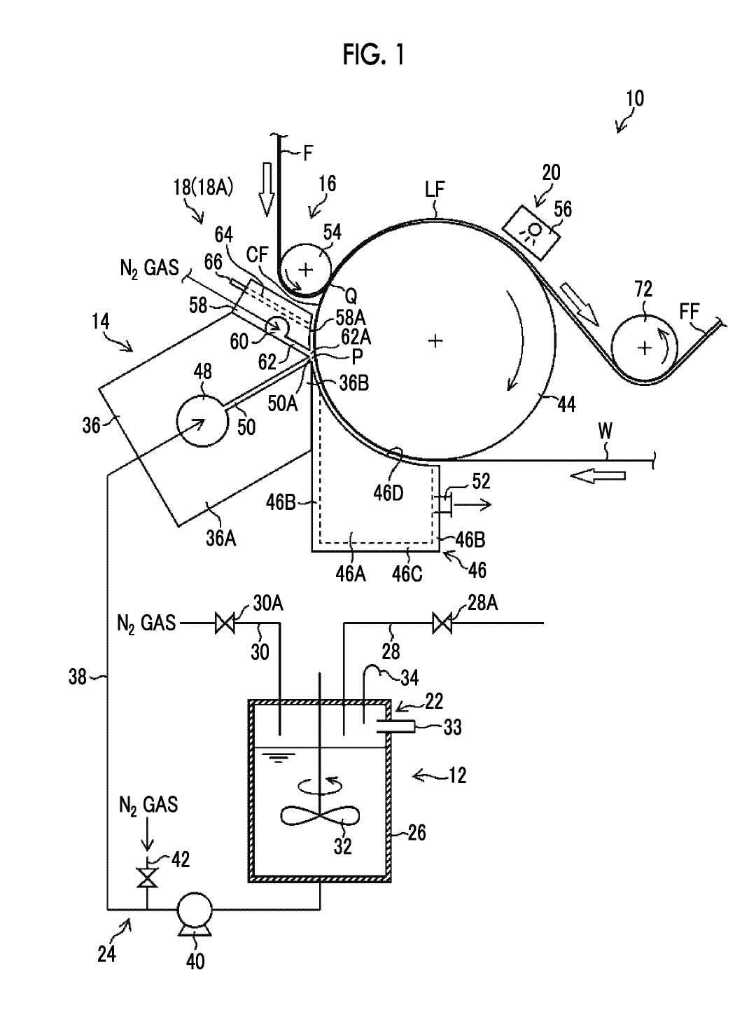

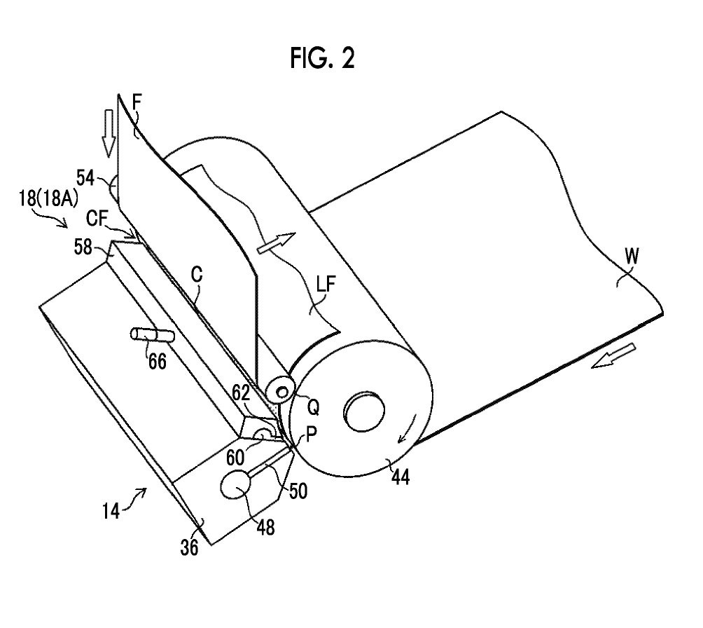

As shown in FIGS. 1 to 3, an apparatus 10 for producing a functional film mainly includes a dissolved oxygen reducing device 12 which reduces a dissolved oxygen concentration in a functional layer forming coating solution containing a quantum dot (hereinafter, referred to as “coating solution”) to 1000 ppm or less, a coating device 14 which applies the coating solution, a lamination device 16 which laminates a film F on a coating C formed by coating, an inert gas atmosphere forming device 18 which forms an inert gas atmosphere in a space including the coated surface from a coating start position P to a lamination start position Q, and a curing device 20 that cures the coating.

In the embodiment, nitrogen gas (N₂ gas) as an example of an inter gas will be described below. In addition, the details of the composition contents of the coating solution containing a quantum dot will be described in the section of a method for producing a functional film.

In addition, in the following description, a film that is obtained by applying the coating solution to a flexible support W is referred to as a coated film CF, a film that is obtained by laminating a film F on the coated film CF is referred to as a laminated film LF and a film having an optical functional layer that is obtained by performing a curing treatment on a coating C of the laminated film LF is referred to as a functional film FF.

(Dissolved Oxygen Reducing Device)

The dissolved oxygen reducing device 12 may adopt any configuration as long as the device can reduce the dissolved oxygen concentration in the coating solution to 1000 ppm or less. For example, the device configuration as shown in FIG. 1 can be suitably adopted.

As shown in FIG. 1, the dissolved oxygen reducing device 12 mainly includes nitrogen gas substituting means 22 and coating solution supply means 24 for supplying the coating solution having reduced dissolved oxygen to the coating device 14.

The nitrogen gas substituting means 22 includes a sealed tank 26 which stores the coating solution, a coating solution pipe 28 which supplies the coating solution into the tank 26, a nitrogen gas pipe 30 which supplies nitrogen gas into the tank 26, and a stirrer 32 which causes the nitrogen gas to be incorporated in the coating solution by stirring the coating solution so as to reduce the amount of dissolved oxygen in the coating solution. An air vent pipe 34 is provided in the tank 26 and opening and closing valves 28A and 30A are respectively provided in the coating solution pipe 28 and the nitrogen gas pipe 30. In addition, a pressure reducing pipe 33 is provided in a head space part of the tank 26 and is connected to a vacuum device (not shown). Thus, the pressure in the tank 26 is reduced, dissolved oxygen in the coating solution is degassed, and in a case where the coating solution contains an organic solvent, the organic solvent is evaporated.

The coating solution supply means 24 includes a liquid feeding pipe 38 and a liquid feeding pump 40 for feeding the coating solution in the tank 26 to a die coater 36 of the coating device 14, and a nitrogen gas blowing pipe 42 for blowing nitrogen gas into the liquid feeding pipe 38 and substituting the air in the liquid feeding pipe 38 and the side (manifold, slit) of the die coater 36 by the nitrogen gas.

Although not shown in FIG. 1, a configuration in which a plurality of nitrogen gas substituting means 22 are arranged in parallel so that the nitrogen gas substituting means 22 can be used by switching between the nitrogen gas substituting means 22 and the coating solution supply means 24 is adopted and thus continuous coating can be performed.

(Coating Device)

As shown in FIG. 1, the coating device 14 mainly includes a backup roller 44, the die coater 36, and a reduced pressure chamber 46.

The die coater 36 is formed in a block long in a coating width direction and has a part where the cross section of a body portion 36A orthogonal to the coating width direction is formed in a rectangular shape and a part where the cross section of a distal end lip portion 36B is formed in a triangular shape. In the die coater 36, a manifold 48 which expands a flow of the coating solution supplied to the die coater 36 in the coating width direction, and a narrow slit 50 (also referred to as a slot) which discharges the flow-expanded coating solution from a discharging port 50A at the distal end of the distal end lip portion 36B are formed.

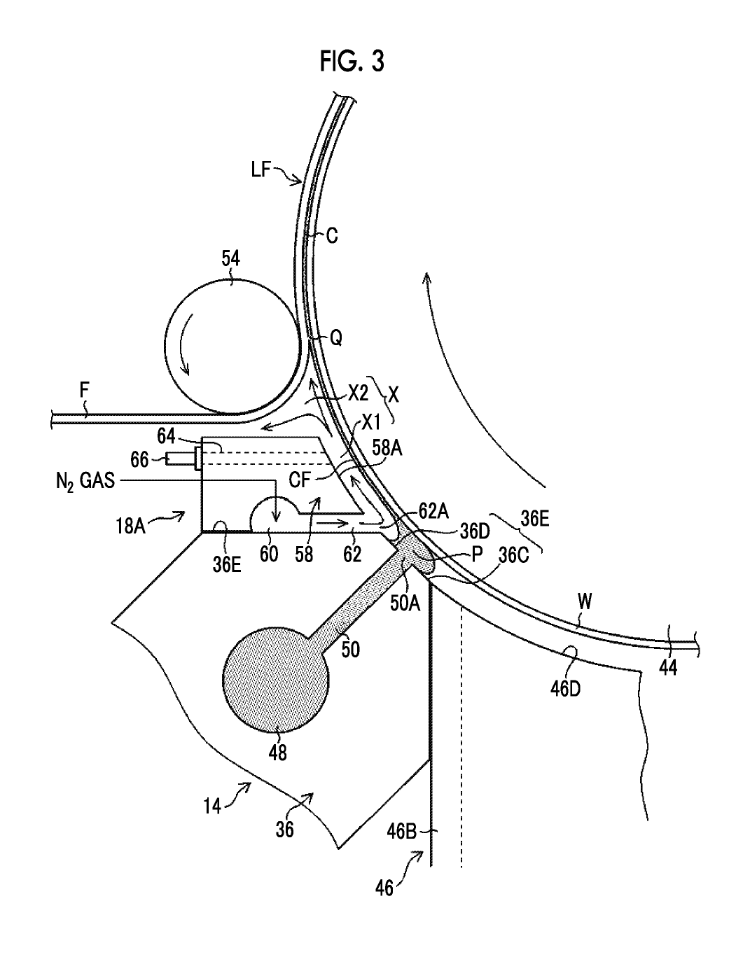

On the distal end surface of the distal end lip portion 36B of the slit 50 in which the discharging port 50A is formed, a flat portion called a land 36E is formed, and as seen from a transport direction of the flexible support W which is transported in a state in which the support is wound around the backup roller 44, the land 36E on an upstream side of the slit is referred to as an upstream side lip land 36C and a land on a downstream side thereof is referred to as a downstream side lip land 36D (refer to FIG. 3).

In addition, on the lower side of the distal end lip portion 36B of the die coater 36 (the upstream side of the die coater as seen from the transport direction of the flexible support W), the reduced pressure chamber 46 is arranged opposite to the backup roller 44.

The reduced pressure chamber 46 is formed in a box having an opening 46D formed along the roller surface of the backup roller 44 by a pair of side plates 46A and 46A, a pair of back plates 46B and 46B, and a bottom plate 46C. Between an upper end of the side plate 46A and the flexible support W which is transported in a state in which the support is wound around the backup roller 44, and between an upper end of the back plate 46B and the flexible support W, gaps to a degree of avoiding contact with each other are formed.

The inside of the reduced pressure chamber 46 is connected to a blower (not show n) through a pipe 52 and the pressure in the reduced pressure chamber 46 is reduced by operating the blower. The pressure reduction degree of the reduced pressure chamber 46 can be set to, for example, 10 Pa to 2000 Pa with respect to the atmospheric pressure.

Due to the above-described configuration, the coating solution discharged from the slit 50 of the die coater 36 forms a coating solution bead between the land 36E and the flexible support W which is transported in a state in which the support is wound around the backup roller 44 and the coating solution is applied to the flexible support W through the bead. In addition, since the reduced pressure chamber 46 is provided, the bead is formed in a stabilized state and the coating solution is applied to the flexible support W with high accuracy. Thus, the coated film CF formed by forming the coating C of the coating solution containing a quantum dot is formed.

As described above, since the low dissolved oxygen concentration coating solution having a dissolved oxygen concentration of 1000 ppm or less is supplied to the die coater 36 of an extrusion coating type constituted by the manifold 48 and the slit 50 and not easily allowing contact with external air and applied to the flexible support W which is transported in a state in which the support is wound around the backup roller 44, compared to other coating devices such as a gravure coater and a roll coater, a chance of contact between the coating solution and external air (oxygen in external air) can be reduced.

(Lamination Device)

As shown in FIG. 1, the lamination device 16 is a device which laminates a film F on the coated surface of the coated film CF on the backup roller 44 and includes the backup roller 44 that is also used in the coating device 14, and a lamination roller 54 arranged opposite to the backup roller 44 on the downstream side of the coating device 14 as seen from a rotation direction of the backup roller 44. Thus, the lamination roller 54 and the backup roller 44 constitute a nip roller.

By performing nip operation by the lamination roller 54 and the backup roller 44, a film F is laminated on the coated surface of the coated film CF. Thus, a laminated film LF in which the coating C is sandwiched between the flexible support W and the film F is formed.

Regarding the nip pressure by the lamination roller 54 and the backup roller 44, it is preferable that the film F is laminated on the coating C by performing nipping at a line pressure of 0 to 300 N/cm, it is more preferable that the film F is laminated on the coating C by performing nipping at a line pressure of 0 to 200 N/cm, and it is particularly preferable that the film F is laminated on the coating C by performing nipping at a line pressure of 0 to 100 N/cm. Then, in the line pressure range of 0 to 300 N/cm, zero tension lamination at a line pressure of 0 N/cm is most preferable.

A distance between the lamination roller 54 and the backup roller 44 is equal to or longer than the length of the total thickness of the flexible support W, an optical functional layer formed by curing the coating C by polymerization, and the film F and is preferably equal to or shorter than a length obtained by adding 5 mm to the total thickness. By setting the distance between the lamination roller 54 and the backup roller 44 to be equal to or shorter than the length obtained by adding 5 mm to the total thickness, it is possible to suppress intrusion of bubbles between the film F and the coating C. Herein, the distance between the lamination roller 54 and the backup roller 44 refers to the shortest distance between the outer peripheral surface of the lamination roller 54 and the outer peripheral surface of the backup roller 44.

In order to suppress thermal deformation after the coating C is sandwiched between the flexible support W and the film F, a difference between the temperature of the backup roller 44 and the temperature of the flexible support W, and a difference between the temperature of the backup roller 44 and the temperature of the film F are preferably 30° C. or lower, and more preferably 15° C. or lower, and most preferably, the temperatures are the same.

The flexible support W may be heated by winding the flexible support W around the backup roller 44 of which temperature is adjusted. On the other hand, regarding the film, the film F can be heated by using the lamination roller 54 as a heat roller (heating roller). However, the temperature adjustment of the backup roller 44 and the heat roller of the lamination roller 54 are not required and can be provided if necessary.

As described above, by laminating the coating C formed by applying the coating solution to the flexible support W on the film F, a chance of contact of the coating C with external air is eliminated and performance deterioration of the quantum dot can be prevented.

(Inert Gas Atmosphere Forming Device)

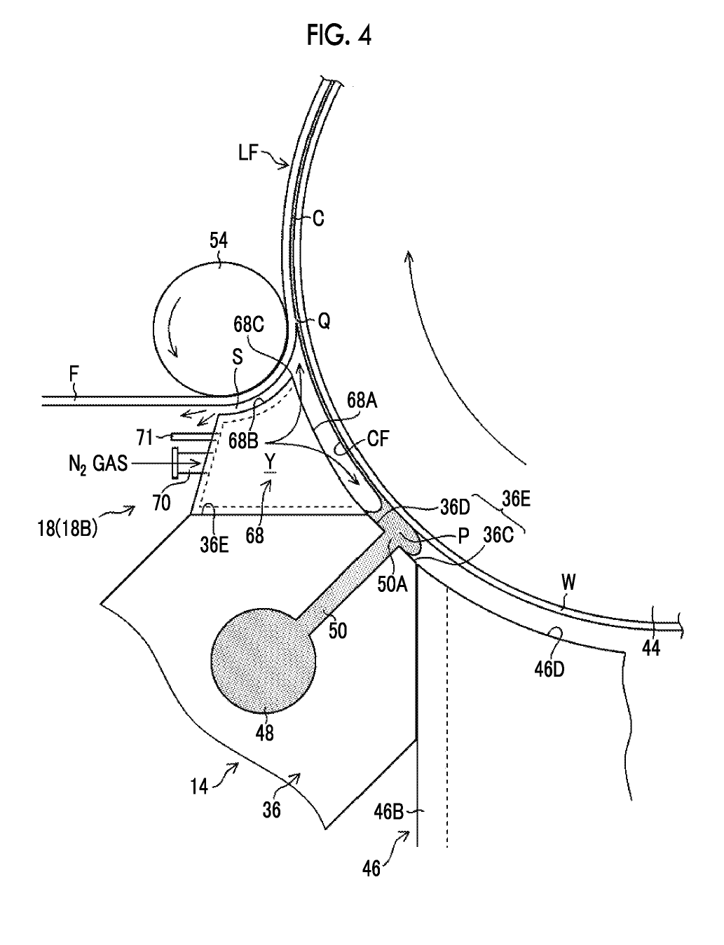

The inert gas atmosphere forming device 18 may be any device as long as the device can form nitrogen gas (inert gas) atmosphere in a space X including a coated surface from a coating start position P to a lamination start position Q on the backup roller 44. Any of a die block type device shown in FIGS. 1 to 3 and a cover member type device shown in FIG. 4 can be suitably adopted.

Herein, the coating start position P refers to a coating start position where the coating solution is discharged from the slit 50 of the die coater 36 and is applied to the flexible support W. In addition, the lamination start position Q refers to a nip position where the coating C is sandwiched by the lamination roller 54 and backup roller 44 and the flexible support W and film F are nipped by the rollers.

The oxygen concentration in the space including the coated surface from the coating start position P to the lamination start position Q is preferably 100 ppm or less and is more preferably 50 ppm or less.

<Die Block Type Inert Gas Atmosphere Forming Device>

As shown in FIGS. 1 to 3, the die block type inert gas atmosphere forming device 18A is constituted by a die block 58 which is disposed adjacent to the downstream side of the die coater 36 as seen from the transport direction of the flexible support W, has a distal end surface 58A opposite to the roller surface of the backup roller 44, and discharges nitrogen gas from the distal end surface to a width direction of the coated surface.

The die block 58 has the circular arc-like distal end surface 58A opposite to the roller surface of the backup roller 44 and is formed in an approximately rectangular parallelepiped block which is long in the coating width direction of the die coater 36. In the die block 58, a manifold 60 and a slit 62 are formed for discharging nitrogen gas to the width direction of the coated surface.

Thus, a thin layer space X1 (refer to FIG. 3) is formed between the distal end surface 58A of the die block 58 and the coated surface in the transport direction of the coated film CF. In this case, it is preferable that the die block 58 and the lamination roller 54 are brought close to the film F which is transported in a state in which the film is wound around the lamination roller 54 so as not to contact with each other. Thus, as shown in FIG. 3, a triangular space X2 (refer to FIG. 3) having a triangular cross section is formed between the die block 58 and the coated film CF wound around that lamination roller 54 and backup roller 44.

That is, a space X (X1+X2) including the coated surface including the thin layer space X1 between the distal end surface 58A of the die block 58 and the coating C and the triangular space X2 which is formed so as to communicate with the thin layer space X1 is formed from the coating start position P to the lamination start position Q.

In addition, in the embodiment, the manifold 60 and the slit 62 of the die block 58 are formed as follows. That is, a groove which becomes the manifold 60 and a groove which becomes the slit 62 are drilled in the surface of the die block 58 close to the die coater 36. Then, in a state in which the surface of the die block 58 in which the grooves are formed is abutted on a downstream side inclined surface 36E of the distal end lip portion 36B of the die coater 36, which is formed in a triangular shape, the abutted surfaces are bonded to each other.

By forming the manifold 60 and the slit 62 of the die block 58 described above, a discharging port 62A of the silt which discharges nitrogen gas can be arranged just behind the downstream side of the discharging port 50A of the slit of the die coater 36. In this configuration, since the coating C formed on the flexible support W can be directly covered by nitrogen gas, a chance of contact with external air at the coating start position P can be avoided.

In addition, in the die block 58, a measurement hole 64 which penetrates from the circular arc-like distal end surface 58A to the surface opposite to the distal end surface 58A is formed and a connection pipe 66 in which an oxygen concentration meter and a differential pressure gauge (not shown) are freely attachably or detachably connected to the measurement hole 64 formed on the opposite surface are provided. Thus, the oxygen concentration and the pressure of the space X can be measured. In a case where the oxygen concentration and the pressure are measured at the same time, a fork-shaped connection pipe 66 may be provided.

The oxygen concentration of the space X is preferably 100 ppm or less as described above. In addition, the pressure of the space X is preferably a positive pressure higher than the outside air pressure (atmospheric pressure) so that accompanied air accompanied by the flexible support W which is transported in a state in which the support is wound around the backup roller 44 or accompanied air accompanied by the film F which is transported in a state in which the film is wound around the lamination roller 54 is not carried in the space X.

<Cover Member Type Inert Gas Atmosphere Forming Device>

As shown in FIG. 4, a cover member type inert gas atmosphere forming device 18B mainly includes a cover member 68 which covers a space Y including a coated surface from the coating start position P to the lamination start position Q on the backup roller 44 and inert gas supply means (not shown) for supplying nitrogen gas into the cover member 68.

The cover member 68 has a circular arc-like opening portion 68A opposite to the roller surface of the backup roller 44, is formed as an approximately rectangular parallelepiped box which is long in the coating width direction of the die coater 36, and is fixed and supported on the downstream side inclined surface 36E of the die coater.

The cover member 68 and the lamination roller 54 are closely arranged so as not to contact with the film F which is transported in a state in which the film is wound around the lamination roller 54 and a side surface 68B of the cover member 68 close to the lamination roller 54 is formed as a circular arc-like side surface opposite to the lamination roller 54.

Thus, a lower end 68C of the side surface 68B of the cover member 68 close to the lamination roller 54 can be made to approach the lamination start position Q as shown in FIG. 4 and the space Y including the coated surface from the coating start position P to the lamination start position Q on the backup roller 44 can be covered by the cover member 68.

In addition, since a gap S between the cover member 68 and the lamination roller 54 can be reduced, the accompanied air accompanied by the film F which is transported in a state in which the film is wound around the lamination roller 54 cannot be carried into the cover member 68 forming the space Y.

In the cover member 68, a nitrogen introducing pipe 70 which introduces nitrogen gas into the cover member 68 is provided and the nitrogen gas is introduced into the cover member 68 from the inert gas supply means (for example, nitrogen cylinder) (not shown).

Further, in the cover member 68, a measurement pipe 71 to which an oxygen concentration meter and a differential pressure gauge (not shown) are freely attachably or detachably connected is provided. Thus, the oxygen concentration and the pressure of the space Y can be measured.

In a case where the oxygen concentration and the pressure are measured at the same time, a fork-shaped measurement pipe 71 may be provided.

The oxygen concentration of the space Y is preferably 100 ppm or less as described above. In addition, the pressure of the space Y is preferably a positive pressure higher than the outside air pressure (atmospheric pressure). Thus, the accompanied air accompanied by the flexible support W which is transported in a state in which the support is wound around the backup roller 44 or the accompanied air accompanied by the film F which is transported in a state in which the film is wound around the lamination roller 54 can be carried in the space Y.

It is possible to provide both the cover member 68 and the die block 58. That is, the die block 58 cannot be arranged in the cover member 68.

(Curing Device)

An optical functional layer can be obtained by polymerizing and curing the coating C by photoirradiation after forming the laminated film LF by laminating the film F on the coated film CF. The curing condition can be appropriately set according to the kind of the curable compound to be used or the composition of a coating solution.

As shown in FIG. 1, the curing device 20 is a device which irradiates the coated surface with an actinic ray and cures the coating C for obtaining an optical functional layer and includes the backup roller 44 also used in the coating device 14, and the lamination device 16, and as seen from the rotation direction of the backup roller 44, an actinic ray irradiation device 56 arranged on the downstream side of the lamination device 16 to be opposite to the backup roller 44.

The laminated film LF is continuously transported between the backup roller 44 and the actinic ray irradiation device 56.

The actinic ray emitted from the actinic ray irradiation device 56 may be determined according to the kind of the curable compound included in the coating solution and for example, ultraviolet rays may be used. For example, as a light source for generating ultraviolet rays, a low pressure mercury lamp, an intermediate pressure mercury lamp, a high pressure mercury lamp, an ultrahigh pressure mercury lamp, a carbon-arc lamp, a metal halide lamp, a xenon lamp, a light emitting diode (LED), laser, and the like can be used. The photoirradiation dose may be set to be in a range in which polymerization and curing of the coating C can proceed and for example, the coating C can be irradiated with ultraviolet rays at an irradiation dose of 10 to 10000 mJ/cm². The photoirradiation dose to the coating C can be set to, for example, 10 to 10000 mJ/cm² and is preferably 10 to 1000 mJ/cm² and more preferably 50 to 800 mJ/cm².

The photoirradiation atmosphere of the actinic ray irradiation device 56 is preferably a low oxygen atmosphere formed by nitrogen purge or the like.

The temperature of the backup roller 44 can be determined in consideration of heat generation at photoirradiation, the curing efficiency of the coating C, and the generation of winkle deformation of the laminated film LF on the backup roller 44. For example, the temperature of the backup roller 44 is preferably set to be in a temperature range of 10° C. to 95° C., and more preferably set to be in a temperature range of 15° C. to 85° C. Herein, the temperature of the backup roller refers to the surface temperature of the roller.

By performing curing on the backup roller 44, which is the same roller for performing coating and lamination, as described above, while maintaining a state in which the laminated film LF is supported by the backup roller 44 without being slackened, the coated surface is irradiated with an actinic ray and cured. Thus, a functional film FF to be produced can be prevented from being wrinkled and the performance of the functional film FF can be further improved.

In a case where the die coater 36 of the coating device 14, the lamination roller 54 of the lamination device 16, and the actinic ray irradiation device 56 of the curing device 20 are arranged above the backup roller 44, the diameter of the backup roller 44 is preferably in a range of 150 to 800 mm.

The diameter of the backup roller 44 is mainly related to productivity in functional film production and in a case where the diameter of the backup roller 44 is in a range of 150 to 800 mm, the productivity is satisfactory. That is, in a case where the diameter of the backup roller 44 is less than 150 mm, the size of the devices (die coater 36, lamination roller 54, and actinic ray irradiation device 56) to be arranged above the backup roller 44 has to be reduced and thus the device capability is also decreased. Accordingly, in order to compensate the decreased device capability, the transport speed of the flexible support W has to be decreased and thus productivity in functional film production is decreased. In addition, in a case where the diameter of the backup roller 44 is more than 800 mm, the transport path of the flexible support W is increased by the increased size of the diameter and thus productivity in functional film production is decreased.

In the embodiment, the method of performing polymerization and curing by photoirradiation is described but in a case where the curable compound included in the coating solution is cured by heating (thermosetting compound), a curing device which performs a curing treatment by heating can be used.

In addition, in the embodiment, the curing device 20 is arranged above the backup roller 44 as in the case of the coating device 14 and the lamination device 16 but there is no limitation thereto. The laminated film LF is formed by sandwiching the coating C between the flexible support W and the film F by the lamination device 16 to protect the coating C from external air (oxygen in external air). Accordingly, the curing device 20 can be arranged on a roller subsequent to the backup roller 44, for example, a pass roller.

[Method for Producing Functional Film]

Next, a method for producing a functional film FF having an optical functional layer with a coating solution containing a quantum dot using the apparatus 10 for producing a functional film according to the embodiment of the present invention configured as described above will be described.

(Coating Solution Preparation Step)

In a coating solution preparation step, each of components of a quantum dot (or a quantum rod), a curable compound, a thixotropic agent, a polymerization initiator, a silane coupling agent, and the like is mixed in a tank or the like to prepare an optical functional layer forming coating solution (hereinafter, also referred to as “coating solution”).

<Quantum Dot and Quantum Rod>

A quantum dot is a fine particle of a compound semiconductor having a size of several nm to several tens of nm and is at least excited by incidence exciting light to emit fluorescent light.

The quantum dot included in the coating solution of the embodiment can include at least one quantum dot, or also two or more quantum dots having different light emission properties. A known quantum dot includes a quantum dot (A) having a center emission wavelength in the wavelength range in the range of 600 nm to 680 nm, a quantum dot (B) having a center emission wavelength in the wavelength range in the range of 500 nm to 600 nm, and a quantum dot (C) having a center emission wavelength in the wavelength range in the range of 400 nm to 500 nm. The quantum dot (A) is excited by exciting light to emit red light, the quantum dot (B) is excited by exciting light to emit green light and the quantum dot (C) is excited by exciting light to emit blue light. For example, in a case where blue light is incident as exciting light on an optical functional layer including the quantum dots (A) and the quantum dot (B), white light can be can realized by red light emitted from the quantum dot (A), green light emitted from the quantum dot (B) and blue light penetrating through the optical functional layer. Alternatively, in a case where ultraviolet light can be incident as exciting light on a functional film having an optical functional layer including the quantum dots (A), (B) and (C), white light can be can realized by red light emitted from the quantum dot (A), green light emitted from the quantum dot (B) and blue light emitted from the quantum dot (C).

With respect to the quantum dot, those described in, for example, paragraphs 0060 to 0066 in JP2012-169271A can be referenced, but the quantum dot is not limited to those. For the quantum dot, a commercially available product can be used without any limitation. The emission wavelength of the quantum dot can be usually adjusted by the composition and the size of a particle.

The quantum dot can be added in an amount of, for example, about 0.1 to 10 parts by mass with respect to 100 parts by mass of the total amount of the coating solution.

The quantum dot may be added to the coating solution in the form of a particle and may be added to the polymerizable composition in the form of a dispersion liquid in which the quantum dots are dispersed in an organic solvent. It is preferable to add the quantum dot in the form of a dispersion liquid from the viewpoint of suppressing aggregation of quantum dot particles. The organic solvent used to disperse the quantum dots is not particularly limited.

However, it is required that the content of the volatile organic solvent in the coating solution supplied to the coating device 14 is reduced to 10000 ppm or less and preferably reduced to 1000 ppm or less.

Therefore, in a case where the quantum dots are added to the coating solution in the form of a dispersion liquid in which the quantum dots are dispersed in the organic solvent, it is required to dry the organic solvent in the coating solution before the coating solution is applied to the flexible support W. That is, at the time when the coating solution is supplied to the coating device 14, the coating solution does not substantially include the organic solvent.

A volatile organic solvent refers to a compound which has a boiling point of 160° C. or lower, is not cured by the curable compound in the coating solution and external stimulus, and is in a liquid state at 20° C. The boiling point of the volatile organic solvent is preferably 160° C. or lower, more preferably 115° C. or lower, and most preferably 30° C. or higher and 100° C. or lower.

As the method for drying the organic solvent in the coating solution, any method may be used as long as the ratio of the organic solvent in the coating solution can be set to 10000 ppm or less. For example, the organic solvent can be volatilized by an operation of substituting air (oxygen) in the coating solution in the tank 26 of the dissolved oxygen reducing device 12 by nitrogen gas while reducing the pressure in the tank 26. In this case, it is preferable to provide heating means in the tank 26 so as to make volatilization of the organic solvent easy.

A quantum rod can be used instead of the quantum dot. The quantum rod is a particle having an elongated rod shape and has the same properties as those of the quantum dot. The amount of the quantum rod to be added and the method for adding the quantum rod to the coating solution may be the same as the amount of the quantum dot and the method for adding the quantum dot, respectively. The quantum dot and the quantum rod can also be used in combination.

<Curable Compound>

As the curable compound used in the embodiment, a compound having a polymerizable group may be adopted. The kind of the polymerizable group is not particularly limited and the polymerizable group is preferably a (meth)acrylate group, a vinyl group, or an epoxy group, more preferably a (meth)acrylate group, and still more preferably an acrylate group. In addition, with respect to a polymerizable monomer having two or more polymerizable groups, the respective polymerizable groups may be the same or different.

—(Meth)Acrylate-Based—

From the viewpoint of transparency, adhesiveness and the like of a cured coated film after curing, a (meth)acrylate compound such as a monofunctional or polyfunctional (meth)acrylate monomer, a polymer or prepolymer thereof, or the like is preferable. In the present invention and specification, the term “(meth)acrylate” is used to mean at least one or any one of acrylate and methacrylate. The same applies to the term “(meth)acryloyl” and the like.

—Bifunctional Monomer—

As a polymerizable monomer having two polymerizable groups, for example, a bifunctional polymerizable unsaturated monomer having two ethylenically unsaturated bond-containing groups can be used. The bifunctional polymerizable unsaturated monomer is suitable for allowing a composition to have a low viscosity. In the embodiment, a (meth)acrylate-based compound having excellent reactivity and having no problems such as a remaining catalyst is preferable.

In particular, neopentyl glycol di(meth)acrylate, 1,9-nonanediol di(meth)acrylate, dipropylene glycol di(meth)acrylate, tripropylene glycol di(meth)acrylate, tetraethylene glycol di(meth)acrylate, hydroxypivalate neopentyl glycol di(meth)acrylate, polyethylene glycol di(meth)acrylate, dicyclopentenyl(meth)acrylate, dicyclopentenyl oxyethyl(meth)acrylate, dicyclopentanyl di(meth)acrylate, or the like is suitably used in the present invention.

The amount of the bifunctional (meth)acrylate monomer to be used is preferably 5 parts by mass or more and more preferably 10 to 80 parts by mass with respect to 100 parts by mass of the total amount of the curable compound included in the coating solution from the viewpoint of adjusting the viscosity of the coating solution to be in a preferable range.

—Tri- or Higher Functional Monomer—

As a polymerizable monomer having three or more polymerizable groups, for example, a polyfunctional polymerizable unsaturated monomer having three or more ethylenically unsaturated bond-containing groups can be used. The polyfunctional polymerizable unsaturated monomer is preferable from the viewpoint of imparting mechanical strength. In the embodiment, a (meth)acrylate-based compound having excellent reactivity and having no problem of a remaining catalyst is preferable.

Specifically, epichlorohydrin (ECH)-modified glycerol tri(meth)acrylate, ethylene oxide (EO)-modified glycerol tri(meth)acrylate, propylene oxide (PO)-modified glycerol tri(meth)acrylate, pentaerythritol triacrylate, pentaerythritol tetraacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl)isocyanurate, dipentaerythritol hexa(meth)acrylate, dipentaerythritol penta(meth)acrylate, caprolactone-modified dipentaerythritol hexa(meth)acrylate, dipentaerythritol hydroxy penta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxy tetra(meth)acrylate, or pentaerythritol tetra(meth)acrylate is suitable.

Among these, in particular, EO-modified glycerol tri(meth)acrylate, PO-modified glycerol tri(meth)acrylate, trimethylolpropane tri(meth)acrylate. EO-modified trimethylolpropane tri(meth)acrylate, PO-modified trimethylolpropane tri(meth)acrylate, dipentaerythritol hexa(meth)acrylate, dipentaerythritol penta(meth)acrylate, pentaerythritolethoxy tetra(meth)acrylate, or pentaerythritol tetra(meth)acrylate is suitably used in the present invention.

The amount of the polyfunctional (meth)acrylate monomer to be used is preferably 5 parts by mass or more with respect to 100 parts by mass of the total amount of the curable compound included in the coating solution from the viewpoint of the coated film hardness of an optical functional layer after curing, and more preferably 95 parts by mass or less with respect to 100 parts by mass of the total amount of the curable compound from the viewpoint of suppressing gelation of the coating solution.

—Monofunctional Monomer—

As the monofunctional (meth)acrylate monomer, acrylic acid and methacrylic acid, and derivatives thereof, more specifically, a monomer having one polymerizable unsaturated bond ((meth)acryloyl group) of (meth)acrylic acid in one molecule may be used. Specific examples thereof include the following compounds, but the present embodiment is not limited thereto.

Examples thereof include alkyl(meth)acrylates having 1 to 30 carbon atoms in the alkyl group, such as methyl(meth)acrylate, n-butyl(meth)acrylate, isobutyl(meth)acrylate, 2-ethylhexyl(meth)acrylate, isononyl(meth)acrylate, n-octyl(meth)acrylate, lauryl(meth)acrylate and stearyl(meth)acrylate; aralkyl(meth)acrylates having 7 to 20 carbon atoms in the aralkyl group, such as benzyl(meth)acrylate; alkoxyalkyl(meth)acrylates having 2 to 30 carbon atoms in the alkoxyalkyl group, such as butoxyethyl(meth)acrylate; aminoalkyl(meth)acrylates having 1 to 20 carbon atoms in total in the (monoalkyl or dialkyl)aminoalkyl group, such as N,N-dimethylaminoethyl(meth)acrylate; polyalkylene glycol alkyl ether(meth)acrylates having 1 to 10 carbon atoms in the alkylene chain and having 1 to 10 carbon atoms in the terminal alkyl ether, such as diethylene glycol ethyl ether(meth)acrylate, triethylene glycol butyl ether(meth)acrylate, tetraethylene glycol monomethyl ether(meth)acrylate, hexaethylene glycol monomethyl ether(meth)acrylate, octaethylene glycol monomethyl ether(meth)acrylate, nonaethylene glycol monomethyl ether(meth)acrylate, dipropylene glycol monomethyl ether(meth)acrylate, heptapropylene glycol monomethyl ether(meth)acrylate and tetraethylene glycol monoethyl ether(meth)acrylate; polyalkylene glycol aryl ether(meth)acrylates having 1 to 30 carbon atoms in the alkylene chain and having 6 to 20 carbon atoms in the terminal aryl ether, such as hexaethylene glycol phenyl ether(meth)acrylate; (meth)acrylate having an alicyclic structure and having 4 to 30 carbon atoms in total, such as cyclohexyl(meth)acrylate, dicyclopentanyl(meth)acrylate, isobornyl(meth)acrylate and methylene oxide addition cyclodecatriene(meth)acrylate; fluorinated alkyl(meth)acrylates having 4 to 30 carbon atoms in total, such as heptadecafluorodecyl(meth)acrylate; (meth)acrylates having a hydroxyl group, such as 2-hydroxyethyl(meth)acrylate, 3-hydroxypropyl(meth)acrylate, 4-hydroxybutyl(meth)acrylate, triethylene glycol mono(meth)acrylate, tetraethylene glycol mono(meth)acrylate, hexaethylene glycol mono(meth)acrylate, octapropylene glycol mono(meth)acrylate and glycerol mono or di(meth)acrylate; (meth)acrylates having a glycidyl group, such as glycidyl(meth)acrylate, polyethylene glycol mono(meth)acrylates having 1 to 30 carbon atoms in the alkylene chain, such as tetraethylene glycol mono(meth)acrylate, hexaethylene glycol mono(meth)acrylate and octapropylene glycol mono(meth)acrylate; and (meth)acrylamides such as (meth)acrylamide, N,N-dimethyl(meth)acrylamide, N-isopropyl(meth)acrylamide, 2-hydroxyethyl(meth)acrylamide and acryloylmorpholine.

The amount of the monofunctional (meth)acrylate monomer to be used is preferably 10 parts by mass or more, and more preferably 10 to 80 parts by mass with respect to 100 parts by mass of the total amount of the curable compound included in the coating solution from the viewpoint of adjusting the viscosity of the coating solution in a preferable range.

—Epoxy-Based Compound and Others—

As the polymerizable monomer used in the embodiment, a compound having a cyclic group such as a ring-opening polymerizable cyclic ether group such as an epoxy group and an oxetanyl group may be used. As such a compound, more preferably, a compound having an epoxy group (epoxy compound) may be used. By using the compound having an epoxy group or an oxetanyl group in combination with the (meth)acrylate-based compound, adhesiveness with a barrier layer tends to be improved.

Examples of the compound having an epoxy group can include polyglycidyl esters of polybasic acid, polyglycidyl ethers of polyhydric alcohol, polyglycidyl ethers of polyoxyalkylene glycol, polyglycidyl ethers of aromatic polyol, hydrogenated compounds of polyglycidyl ethers of aromatic polyol, urethane polyepoxy compounds, and epoxidized polybutadienes. These compounds can be used alone or as a mixture of two or more.

Examples of other compound having an epoxy group, which can be preferably used, can include aliphatic cyclic epoxy compounds, bisphenol A diglycidyl ethers, bisphenol F diglycidyl ethers, bisphenol S diglycidyl ethers, brominated bisphenol A diglycidyl ethers, brominated bisphenol F diglycidyl ethers brominated bisphenol S diglycidyl ethers brominated bisphenol F diglycidyl ethers, brominated bisphenol S diglycidyl ethers, hydrogenerated bisphenol A diglycidyl ethers, hydrogenerated bisphenol F diglycidyl ethers, hydrogenerated bisphenol S diglycidyl ethers, 1,4-butanediol diglycidyl ethers, 1,6-hexanediol diglycidyl ethers, glycerin triglycidyl ethers, trimethylolpropane triglycidyl ethers, polyethylene glycol diglycidyl ethers and polypropylene glycol diglycidyl ethers; polyglycidyl ethers of polyether polyol, obtained by adding one, or two or more alkylene oxides to an aliphatic polyhydric alcohol such as ethylene glycol, propylene glycol or glycerin; diglycidyl esters of aliphatic long chain dibasic acid; monoglycidyl ethers of aliphatic higher alcohol; monoglycidyl ethers of polyether alcohol, obtained by adding an alkylene oxide to phenol, cresol, butyl phenol or these phenols; and glycidyl esters of higher fatty acid.

Among these components, aliphatic cyclic epoxy compounds, bisphenol A diglycidyl ethers, bisphenol F diglycidyl ethers, hydrogenerated bisphenol A diglycidyl ethers, hydrogenerated bisphenol F diglycidyl ethers, 1,4-butanediol diglycidyl ethers, 1,6-hexanediol diglycidyl ethers, glycerin triglycidyl ethers, trimethylolpropane triglycidyl ethers, neopentyl glycol diglycidyl ethers, polyethylene glycol diglycidyl ethers, and polypropylene glycol diglycidyl ethers are preferable.

Examples of a commercially available product, which can be suitably used as the compound having an epoxy group or an oxetanyl group, include UVR-6216 (manufactured by Union Carbide Corporation), glycidol. AOEX24, CYCLOMER A200, CELLOXIDE 2021P and CELLOXIDE 8000 (trade names, these manufactured by Daicel Corporation), 4-vinylcyclohexene dioxide manufactured by Sigma Aldrich, EPIKOTE 828, EPIKOTE 812, EPIKOTE 1031, EPIKOTE 872 and EPIKOTE CT508 (registered trade name: EPIKOTE, these manufactured by Yuka Shell Epoxy K.K.), and KRM-2400, KRM-2410, KRM-2408, KRM-2490, KRM-2720 and KRM-2750 (trade names, these manufactured by Adeka Corporation). These can be used alone or in a combination of two or more.

In addition, regarding these compounds having an epoxy group or an oxetanyl group, any production method thereof may be adopted and the compounds having an epoxy group or an oxetanyl group can be synthesized with reference to Literatures such as “Fourth Edition Experimental Chemistry Course 20 Organic Synthesis II”, p. 213, 1992, published by Maruzen K K; Ed. by Alfred Hasfner, “The chemistry OF heterocyclic compounds-Small Ring Heterocycles part 3 Oxiranes”, John & Wiley and Sons, An Interscience Publication, New York, 1985, Yoshimura. “Bonding”, vol. 29, No. 12, 32, 1985, Yoshimura, “Bonding”, vol. 30, No. 5, 42, 1986, Yoshimura, “Bonding”, vol. 30, No. 7, 42, 1986. JP1999-100378A (JP-H11-100378A), JP2906245B, and JP2926262B.

As the curable compound used in the embodiment, a vinyl ether compound may also be used.

As the vinyl ether compound, a known vinyl ether compound can be appropriately selected, and, for example, one described in paragraph 0057 in JP2009-73078A can be preferably adopted.

These vinyl ether compounds can be synthesized by, for example, the method described in Stephen. C. Lapin, “Polymers Paint Colour Journal”, 179 (4237), 321 (1988), namely, by a reaction of a polyhydric alcohol or a polyhydric phenol with acetylene, or a reaction of a polyhydric alcohol or a polyhydric phenol with a halogenated alkyl vinyl ether, and such method and reactions can be used alone or in combination of two or more.

For the coating solution of the embodiment, a silsesquioxane compound having a reactive group described in JP2009-73078A can also be used from the viewpoint of a decrease in viscosity and an increase in hardness.

<Thixotropic Agent>

The thixotropic agent is an inorganic compound or an organic compound.

—Inorganic Substance—

One preferable aspect of the thixotropic agent is a thixotropic agent of an inorganic substance, and, for example, a needle-like compound, a chain-like compound, a flattened compound or a layered compound can be preferably used. Among these, a layered compound is preferable.

The layered compound is not particularly limited, and examples thereof include talc, mica, feldspar, kaolinite (kaolin clay), pyrophyllite (pyrophyllite clay), sericite, bentonite, smectite and vermiculite (montmorillonite, beidellite, non-tronite, saponite and the like), organic bentonite, and organic smectite.

These can be used alone or in a combination of two or more. Examples of a commercially available layered compound include, as inorganic compounds, CROWN CLAY, BURGESS CLAY #60, BURGESS CLAY KF and OPTIWHITE (trade names, these manufactured by Shiraishi Kogyo Kaisha Ltd.), KAOLIN JP-100, NN KAOLIN CLAY, ST KAOLIN CLAY and HARDSIL (trade names, these manufactured by Tsuchiya Kaolin Ind., Ltd.), ASP-072, SATINTONPLUS, TRANSLINK 37 and HYDROUSDELAMI NCD (trade names, these manufactured by Angel Hard Corporation), SY KAOLIN, OS CLAY, HA CLAY and MC HARD CLAY (trade names, these manufactured by Maruo Calcium Co., Ltd.), RUCENTITE SWN, RUCENTITE SAN, RUCENTITE STN, RUCENTITE SEN AND RUCENTITE SPN (trade names, these manufactured by Co-op Chemical Co., Ltd.), SUMECTON (trade name, manufactured by Kunimine Industries Co., Ltd.), Bengel, BENGEL FW, ESBEN, ESBEN 74, ORGANITE AND ORGANITE T (trade names, these manufactured by Hojun Co., Ltd.), HODAKA JIRUSHI, ORBEN, 250M, BENTONE 34 AND BENTONE 38 (trade names, these manufactured by Wilbur-Ellis Company), and LAPONITE, LAPONITE RD AND LAPONITE RDS (trade names, these manufactured by Nippon Silica Industrial Co., Ltd.). These compounds may also be dispersed in a solvent.

The thixotropic agent to be added to the coating solution is, among the layered inorganic compounds, a silicate compound represented by xM(I)₂O.ySiO₂ (also including a compound corresponding to M(II)O or M(III)₂O₃ having an oxidation number of 2 or 3; x and y represent a positive number), and a further preferable compound is a swellable layered clay mineral such as hectorite, bentonite, smectite or vermiculite.

Particularly preferably, a layered (clay) compound modified by an organic cation (a silicate compound in which an interlayer cation such as sodium is exchanged with an organic cation compound) can be suitably used, and examples thereof include sodium magnesium silicate (hectorite) in which a sodium ion is exchanged with an ammonium ion described below.

Examples of the ammonium ion include a monoalkyltrimethylammonium ion, a dialkyldimethylammonium ion and a trialkylmethylammonium ion having an alkyl chain having 6 to 18 carbon atoms, a dipolyoxyethylene-palm-oil-alkylmethylammonium ion and a bis(2-hydroxyethyl)-palm-oil-alkylmethylammonium ion having 4 to 18 oxyethylene chains, and a polyoxypropylene methyldiethylammonium ion having 4 to 25 oxopropylene chains. These ammonium ions can be used alone or in a combination of two or more.

The method for producing an organic cation-modified silicate mineral in which a sodium ion of sodium magnesium silicate is exchanged with an ammonium ion is such that sodium magnesium silicate is dispersed in water and sufficiently stirred, and thereafter left to still stand for 16 hours or more to prepare a 4% by mass dispersion liquid. While this dispersion liquid is stirred, a desired ammonium salt is added in an amount of 30% by mass to 200% by mass relative to sodium magnesium silicate. After the addition, cation exchange occurs to allow hectorite including an ammonium salt between layers to be insoluble in water and precipitated, and thus the precipitate is taken by filtration and dried. In the preparation, heating may also be performed for the purpose of accelerating the dispersion.

A commercially available product of the alkylammonium-modified silicate mineral includes RUCENTITE SAN, RUCENTITE SAN-316, RUCENTITE STN, RUCENTITE SEN and RUCENTITE SPN (trade names, these manufactured by Co-op Chemical Co., Ltd.), and these can be used alone or in a combination of two or more.

In the embodiment, silica, alumina, silicon nitride, titanium dioxide, calcium carbonate, zinc oxide or the like can be used for the thixotropic agent of an inorganic substance. Such a compound can also be if necessary subjected to a treatment for regulation of hydrophilicity or hydrophobicity of the surface.

—Organic Substance—

For the thixotropic agent, a thixotropic agent of an organic substance can be used.

Examples of the thixotropic agent of an organic substance include an oxidized polyolefin and a modified urea.

The above-oxidized polyolefin may be independently prepared, or a commercially available product may be used. Examples of the commercially available product include DISPERLON 4200-20 (trade name, manufactured by Kusumoto Chemicals, Ltd.) and FLOWNON SA300 (trade name, manufactured by Kyoeisha Chemical Co., Ltd.).

The modified urea described above is a reaction product of an isocyanate monomer or an adduct thereof with an organic amine. The modified urea described above may be independently prepared or a commercially available product may be used. Examples of the commercially available product include BYK 410 (manufactured by BYK Japan K.K.).

—Content—

The content of the thixotropic agent is preferably 0.15 to 20 parts by mass, more preferably 0.2 to 10 parts by mass, and particularly preferably 0.2 to 8 parts by mass with respect to 100 parts by mass of the curable compound in the coating solution. In particular, in a case of the thixotropic agent of an inorganic compound, brittleness tends to be improved at a content of 20 parts by mass or less with respect to 100 parts by mass of the curable compound.

<Polymerization Initiator>

The coating solution can include a known polymerization initiator as the polymerization initiator. With respect to the polymerization initiator, for example, paragraph 0037 in JP2013-043382A can be referred to. The amount of the polymerization initiator is preferably 0.1% by mol or more and more preferably 0.5% to 2% by mol with respect to the total amount of the curable compound included in the coating solution. In addition, the amount of the polymerization initiator is preferably 0.1% to 10% by mass and more preferably 0.2% to 8% by mass as the percentage by mass in the entire curable composition excluding the volatile organic solvent.

<Silane Coupling Agent>

The optical functional layer formed of the coating solution including a silane coupling agent can exhibit excellent durability because of being strong in adhesiveness to an adjacent layer due to the silane coupling agent. In addition, the optical functional layer formed of the coating solution including a silane coupling agent is preferable since an adhesiveness condition relationship of adhesiveness A between the flexible support and a barrier layer<adhesiveness B between the optical functional layer and a barrier layer is established. This is mainly because the silane coupling agent included in the optical functional layer forms a covalent bond with the surface of an adjacent layer or the constitutional component of the optical functional layer through a hydrolysis reaction or condensation reaction. In addition, in a case where the silane coupling agent has a reactive functional group such as a radical polymerizable group, formation of a crosslinking structure with the monomer component constituting the optical functional layer can also contribute to improvement in adhesiveness between an adjacent layer and the optical functional layer.

For the silane coupling agent, a known silane coupling agent can be used without any limitation. A preferable silane coupling agent in terms of adhesiveness can include a silane coupling agent represented by Formula (1) described in JP2013-43382A.

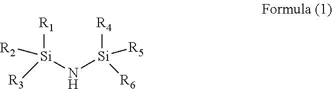

(In Formula (1), R₁ to R₆ each independently represent a substituted or unsubstituted alkyl group or aryl group. Herein, at least one of R₁ to R₆ represents a substituent including a radical polymerizable carbon-carbon double bond.)

R₁ to R₆ each independently represent a substituted or unsubstituted alkyl group or aril group. Except for a case where R₁ to R₆ represent a substituent including a radical polymerizable carbon-carbon double bond, the alkyl group is preferably an unsubstituted alkyl group or unsubstituted aryl group. The alkyl group is preferably an alkyl group having 1 to 6 carbon atoms, and more preferably a methyl group. The aryl group is preferably a phenyl group. R₁ to R₆ each particularly preferably represent a methyl group.

At least one of R₁ to R₆ has a substituent including a radical polymerizable carbon-carbon double bond, and two of R₁ to R₆ preferably have a substituent including a radical polymerizable carbon-carbon double bond. Furthermore, it is particularly preferable that one of R₁ to R₃ has a substituent including a radical polymerizable carbon-carbon double bond and one of R₄ to R₆ has a substituent including a radical polymerizable carbon-carbon double bond.

In a case where the silane coupling agent represented by Formula (1) has two or more substituents including a radical polymerizable carbon-carbon double bond, the respective substituents may be the same or different, and are preferably the same.

It is preferable that the substituent including a radical polymerizable carbon-carbon double bond is represented by —X—Y. Herein, X represents a single bond, an alkylene group having 1 to 6 carbon atoms, or an arylene group, preferably represents a single bond, a methylene group, an ethylene group, a propylene group or a phenylene group. Y represents a radical polymerizable carbon-carbon double bond group, preferably an acryloyloxy group, a methacryloyloyloxy group, an acryloylamino group, a methacryloylamino group, a vinyl group, a propenyl group, a vinyloxy group or a vinylsulfonyl group, and more preferably a (meth)acryloyloxy group.

R₁ to R₆ may also have a substituent other than the substituent including a radical polymerizable carbon-carbon double bond. Examples of such a substituent include alkyl groups (such as a methyl group, an ethyl group, an isopropyl group, a tert-butyl group, a n-octyl group, a n-decyl group, a n-hexadecyl group, a cyclopropyl group, a cyclopentyl group and a cyclohexyl group), aryl groups (such as a phenyl group and a naphthyl group), halogen atoms (such as fluorine, chlorine, bromine and iodine), acyl groups (such as an acetyl group, a benzoyl group, a formyl group and a pivaloyl group), acyloxy groups (such as an acetoxy group, an acryloyloxy group and a methacryloyloxy group), alkoxycarbonyl groups (such as a methoxycarbonyl group and an ethoxycarbonyl group), aryloxycarbonyl groups (such as a phenyloxycarbonyl group), and sulfonyl groups (such as a methanesulfonyl group and a benzenesulfonyl group).

The content of the silane coupling agent in the coating solution is preferably 1% to 30% by mass, more preferably 3 to 30% by mass, and particularly preferably 5% to 25% by mass from the viewpoint of further improvement in adhesiveness to the adjacent layer.

(Dissolved Oxygen Reduction Step)

Next, the coating solution prepared in the coating solution preparation step is adjusted such that the dissolved oxygen concentration in the coating solution is 1000 ppm or less by the dissolved oxygen reducing device 12. In a case where the dissolved oxygen concentration in the coating solution prepared in the coating solution preparation step is 1000 ppm or less, the dissolved oxygen reduction step can be omitted or the dissolved oxygen can be further reduced by the dissolved oxygen reduction step.

In the dissolved oxygen reduction step, the coating solution prepared in the coating solution preparation step is supplied into the tank 26. In this case, it is preferable that nitrogen gas is supplied into the tank 26 from the nitrogen gas pipe 30 and air in the tank 26 is substituted by nitrogen gas in advance before the coating solution is supplied into the tank 26.

While nitrogen gas is being supplied into the tank 26 from the nitrogen gas pipe 30, the coating solution in the tank 26 is stirred by the stirrer 32 and the dissolved oxygen dissolved in the coating solution is changed to nitrogen gas. In this case, it is preferable that the pressure in the tank 26 is reduced by operating the vacuum device connected to the pressure reducing pipe 33 and an operation of degassing the dissolved oxygen in the coating solution reducing is performed. Thus, the concentration of dissolved oxygen dissolved in the coating solution is preferably reduced to 1000 ppm or less, more preferably reduced to 500 ppm or less, and particularly preferably reduced to 100 ppm or less.

Whether or not the dissolved oxygen concentration in the coating solution is 1000 ppm or less can be measured using a dissolved oxygen meter (not shown) by sampling the coating solution from the tank 26 without contact with external air. In addition, although not shown in the drawing, the dissolved oxygen concentration in the coating solution may be automatically measured by attaching a bypass pipe for measurement to the tank 26 and attaching a dissolved oxygen meter to the bypass pipe.

In a case where the volatile organic solvent is used as a dispersion liquid for the quantum dot, the ratio of the organic solvent is preferably set to 10000 ppm or less and more preferably set to 1000 ppm or less by operating the vacuum device connected to the pressure reducing pipe 33 and performing stirring operation of nitrogen gas substitution.

Next, the liquid feeding pump 40 is operated to feed the coating solution in the tank 26 to the manifold 48 of the die coater 36. In this case, it is preferable that nitrogen gas is blown into the liquid feeding pipe 38 from the nitrogen gas blowing pipe 42 before the coating solution in which the dissolved oxygen is reduced by the dissolved oxygen reducing device 12 is fed to the die coater 36 of the coating device 14. Thus, air in the liquid feeding pipe 38 and in the inside (manifold 48, slit 50) of the die coater 36 can be substituted by the nitrogen gas in advance.

Accordingly, while a state in which the dissolved oxygen in the coating solution is reduced to 1000 ppm or less in the dissolved oxygen reduction step is being maintained, the coating solution can be supplied to the die coater 36.

(Coating Step)

Next, in a coating step, the coating solution supplied to the manifold 48 of the die coater 36 is applied to the flexible support W which is transported in a state in which the support is wound around the backup roller 44 to form a coated film CF.

That is, the flow of the coating solution supplied to the manifold 48 is expanded in an coating width direction by the manifold 48, then flows along the slit 50, and is discharged from the discharging port 50A of the slit to the flexible support W to be transported. Thus, a coating solution bead is formed a clearance between the land 36E of the die coater 36 and the flexible support W.

In the coating step, the pressure of the reduced pressure chamber 46 is reduced and a stable bead is formed. Thus, the coating solution can be applied to the flexible support W through the bead with high accuracy.

By applying the coating solution to the flexible support W using an extrusion type coating device 14 constituted by the backup roller 44 and the die coater 36 and not easily allowing contact with external air in this manner, compared to other coating devices such as a gravure coater and a roll coater, a chance of contact between the coating solution and external air (oxygen in external air) can be reduced. Thus, it is possible to suppress performance deterioration of the quantum dot included in the coating solution by oxygen.

The flexible support W is a belt-like support having a flexibility and is preferably, for example, a transparent support which is transparent to visible light. For example, COSMOSHINE A4100 (trade name) manufactured by Toyobo Co., Ltd., which is a polyethylene terephthalate (PET) film with an easily adhesive layer, can be used.

The expression “transparent to visible light” herein refers to a light transmittance in the visible light region of 80% or more and preferably 85% or more. The light transmittance used for measuring transparency can be calculated according to the method described in JIS-K7105 (JIS: Japan Industrial Standards), that is, by measuring the total light transmittance and the amount of light to be scattered, by use of an integrating sphere light transmittance measuring apparatus, and subtracting the diffuse transmittance from the total light transmittance. With respect to the flexible support, paragraphs 0046 to 0052 in JP2007-290369A and paragraphs 0040 to 0055 in JP2005-096108A can be referred to. The thickness of the flexible support is preferably in a range of 10 to 500 μm, more preferably in a range of 15 to 100 μm, and still more preferably in a range of 25 to 60 μm, from the viewpoint of gas barrier properties, impact resistance, and the like.

In addition, flexible support W to be used is preferably a gas barrier film having excellent barrier properties to oxygen and the formation of the gas barrier film will be described in detail in the section of a gas barrier film forming apparatus which will be described later.

(Lamination Step)

Next, in a lamination step, the film F which is transported in a state in which the film is wound around the lamination roller 54 and the coated film CF which is transported in a state in which the film is wound around the backup roller 44 are interposed and nipped between the lamination roller 54 and the backup roller 44 to laminate the film F on the coated surface of the coated film CF.

Since a laminated film LF having a three layer structure in which the coating C is interposed between the flexible support W and the film F is formed in this manner, a chance of contact of the coating C with external air (oxygen in external air) can be reduced. Thus, it is possible to suppress performance deterioration of the quantum dot included in the coating by oxygen.

The film F used for lamination is preferably a gas barrier film having excellent barrier properties to oxygen as in the case of the flexible support W, and the formation of the gas barrier film will be described in detail in the section of a gas barrier film forming apparatus which will be described later.

(Inert Gas Atmosphere Formation Step)

In an inert gas atmosphere formation step, a nitrogen gas atmosphere is formed in the space X or Y including the coated surface from the coating start position P to the lamination start position Q on the backup roller 44 by the above die block type inert gas atmosphere forming device 18A or cover member type inert gas atmosphere forming device 18B.

<Die Block Type>

In the die block type inert gas atmosphere forming device 18A, nitrogen gas is discharged from the slit 62 of the die block 58 to the coated surface in a coated surface width direction.

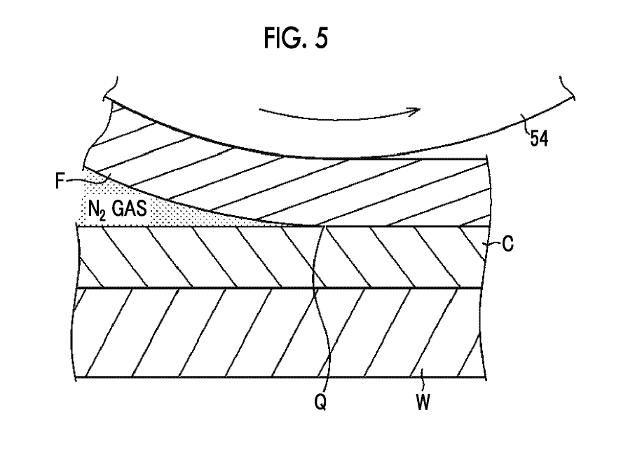

The discharged nitrogen gas flows into the thin layer space X1 between the distal end surface 58A of the die block 58 and the coating C and is accumulated in the triangular space X2. Thus, a nitrogen gas atmosphere can be formed in the space X including the coated surface from the coating start position P to the lamination start position Q on the backup roller 44. As a result, as shown in FIG. 5, the film F is laminated on the coating of the coated film CF under the nitrogen gas atmosphere.

In this case, it is preferable that the gap of the slit 62 of the die block 58 is 0.1 to 2.0 mm and the nitrogen gas is discharged from the slit 62 in a discharge amount of 20 to 500 L/min/m. Thus, since the nitrogen gas atmosphere can be formed by the nitrogen gas discharged from the die block 58 without causing fluctuation or disturbance by waves on the coated surface, evenness in coating thickness related to the performance of the functional film FF is satisfactory.

Herein, the unit “m” of the discharge amount means a unit per 1 m width of the flexible support.

In addition, the nitrogen gas accumulated in the triangular space X2 flows into the gap between the coated film CF and the film F to be laminated and flows to the outside from the gap between the die block 58 and the lamination roller 54.

The nitrogen gas accumulated in the triangular space X2 flows to the outside from the gap between the die block 58 and the lamination roller 54 and thus the accompanied air accompanied by the film F can be prevented from flowing into the triangular space X2.

Whether or not the oxygen concentration of the space X (X1+X2) including the coated surface from the coating start position P to the lamination start position Q is 100 ppm or less is measured using the oxygen concentration meter connected to the measurement hole 64 formed in the die block 58 through the connection pipe 66. Then, the discharge amount of nitrogen gas discharged from the slit 62 of the die block 58 is adjusted such that the oxygen concentration of the space X is 100 ppm or less.

Whether or not the pressure of the space X is a positive pressure is measured using the differential pressure gauge connected to the measurement hole 64 formed in the die block 58 through the connection pipe 66. Then, the discharge amount of nitrogen gas discharged from the slit 62 of the die block 58 is adjusted such that the pressure of the space X is a positive pressure.

In a case where the discharge amount of nitrogen gas in which the oxygen concentration of the space X is 100 ppm or less and the pressure of the space X is a positive pressure is grasped through a preliminary test or the like, it is not necessary to measure the oxygen concentration and the pressure of the space X at all times.

<Cover Member Type>

In the cover member type inert gas atmosphere forming device 18B, nitrogen gas is supplied into the cover member 68 from nitrogen gas supply means (for example, nitrogen cylinder) (not shown). In addition, as in the die block type, using the oxygen concentration meter and the differential pressure gauge connected to the measurement pipe 71 formed in the cover member 68, the oxygen concentration and the differential pressure of the space Y including the coated surface from the coating start position P to the lamination start position Q are measured. Then, the supply amount of nitrogen gas supplied into the cover member 68 is adjusted such that the oxygen concentration of the space Y is 100 ppm or less and the pressure of the space is a positive pressure.

As described above, since the lamination step is performed on the backup roller 44 on which the coating step is performed even in the inert gas atmosphere formation step of any of a die block type and a cover member type, the transport distance of the coated film CF from the coating start position P to the lamination start position Q can be shortened. In addition, since the surface of the coated film CF close to the flexible support W is supported by the backup roller 44 and does not contact with external air, the nitrogen gas atmosphere may be formed on only the coated surface.

Thus, since the volume of the space including the coated surface from the coating start position P to the lamination start position Q can be reduced as much as possible, a nitrogen gas atmosphere of an oxygen concentration of 100 ppm or less can be efficiently formed in the space X or Y with a small amount of nitrogen gas and a nitrogen gas concentration distribution in the space X or Y can be reduced.

In particular, since the thin layer space X1 can be formed between the distal end surface 58A of the die block 58 and the coated surface in the die block type, compared to the cover member type, an inert gas atmosphere of an oxygen concentration of 100 ppm or less can be efficiently formed in the space X with a smaller amount of nitrogen gas and a nitrogen gas concentration distribution in the space X can be reduced.

For example, in the die block type, the oxygen concentration in the space X can be set to 100 ppm or less with a small amount of nitrogen gas (for example, about 50 L/min/m), and the discharged nitrogen gas forms a nitrogen gas layer on the coated surface. Thus, the effect of further suppressing an oxygen concentration distribution on the coated surface is exhibited.

(Curing Step)

In a curing step, while the laminated film LF in which the coating C is sandwiched between the flexible support W and the film F is being continuously transported onto the backup roller 44, photoirradiation from the actinic ray irradiation device 56 is performed to cure the coating C. Thus, an optical functional layer is formed. In addition, since the curing step is performed on the backup roller 44, it is possible to suppress wrinkle generation in the produced functional film FF.

Since the functional film FF can be obtained through the above steps, the obtained functional film FF is peeled from the backup roller 44 by a peeling roller 72, then continuously transported to a winding machine (not shown), and rolled in a roll shape.

However, in the method for producing a functional film according to the present invention, since easiness to degradation with respect to oxygen varies depending on materials whose performance is deteriorated by oxygen, the film F to be laminated on the flexible support W and the coating C to which the coating solution is applied is not limited to a gas barrier film in which a gas barrier layer having barrier properties to oxygen is formed.

However, in a case where a material performance is deteriorated by oxygen is the quantum dot in the embodiment, it is preferable to use a gas barrier film as at least one of films F to be laminated on the flexible support W and the coating C to which the coating solution is applied.

The barrier layer may include at least an inorganic layer and may include at least one inorganic layer and at least one organic layer on a support for forming a gas barrier film. It is preferable to laminate a plurality of layers in this manner from the viewpoint of light resistance since the barrier properties can be further improved. On the other hand, as the number of laminated layers increases, the light transmittance of the optical functional layer tends to further decrease. Thus, it is desirable to increase the number of laminated layer in a range in which satisfactory light transmittance can be maintained.

Specifically, the total light transmittance of the barrier layer in a visible light range is preferably 80% or more and the oxygen permeability of the barrier layer is preferably 1.00 cm³/(m²·day·atm) or less. The total light transmittance refers to an average light transmittance value in a visible light range.

The oxygen permeability of the barrier layer is more preferably 0.1 cm³/(m²·day·atm) or less, particularly preferably 0.01 cm³/(m²·day·atm) or less, and more particularly preferably 0.001 cm³/(m²·day·atm) or less. Herein, the oxygen permeability is a value measured using an oxygen gas permeability measuring apparatus (trade name: OX-TRAN 2/20, manufactured by MOCON Inc.) under the conditions of a measurement temperature of 23° C. and a relative humidity of 90%. In addition, the visible light range refers to a wavelength range of 380 to 780 nm and the total light transmittance indicates an average light transmittance value excluding the contribution of light absorption and reflection of the optical functional layer.

The total light transmittance in the visible light range is more preferably 90% or more. The lower the oxygen permeability is, the more preferable it is, and the higher the total light transmittance in the visible light range is, the more preferable it is.

—Inorganic Layer—

The inorganic layer is a layer having an inorganic material as a main component and is preferably a layer formed of only an inorganic material.

The inorganic layer is preferably a layer having a gas barrier function of blocking oxygen. Specifically, the oxygen permeability of the inorganic layer is preferably 1.00 cm³/(m²·day·atm) or less. The oxygen transmission coefficient of the inorganic layer can be obtained by attaching a wavelength conversion layer to a detection portion of an oxygen concentration meter, manufactured by Orbisphere Laboratories, with silicon grease, and converting an average oxygen concentration value into an oxygen transmission coefficient. The inorganic layer preferably has a function of blocking water vapor.

Two or three or more inorganic layers may be included in the barrier layer.

The inorganic material constituting the inorganic layer is not particularly limited and for example, metal and various inorganic compounds such as inorganic oxide, nitride, and oxynitride can be used. As elements constituting the inorganic material, silicon, aluminum, magnesium, titanium, tin, indium, and cerium are preferable and one or two or more of these may be contained. Specific examples of the inorganic compound include silicon oxide, silicon oxynitride, aluminum oxide, magnesium oxide, titanium oxide, tin oxide, indium oxide alloy, silicon nitride, aluminum nitride, and titanium nitride. In addition, as the inorganic layer, a metal film, for example, an aluminum film, a silver film, a tin film, a chromium film, a nickel film, or a titanium film may be provided.

Among these materials, it is particularly preferable that the inorganic layer having barrier properties is an inorganic layer including at least one compound selected from silicon nitride, silicon oxynitride, silicon oxide, or aluminum oxide. Since the inorganic layer formed of these materials has satisfactory adhesiveness with the organic layer, even in a case where the inorganic layer has pinholes, the organic layer can effectively fill the pinholes and fractures can be suppressed. Further, a very satisfactory inorganic layer film can be formed even in a case where the inorganic layers are laminated, and barrier properties can be further improved.

The method for forming the inorganic layer is not particularly limited and for example, various film formation methods capable of accumulating film forming materials on a surface to be vapor-deposited by evaporating or scattering the film forming materials can be used.

Examples of the method for forming the inorganic layer include a vacuum vapor deposition method of heating and vapor-depositing an inorganic material such as inorganic oxide, inorganic nitride, inorganic oxynitride, or metal; an oxidation reaction vapor deposition method of using an inorganic material as a raw material, oxidizing the inorganic material by introducing an oxygen gas, and vapor-depositing the material; a sputtering method of using an inorganic material as a target raw material, introducing an argon gas and an oxygen gas, and vapor-depositing the material by sputtering; a physical vapor deposition method (PVD method) such as an ion plating method of heating an inorganic material by a plasma beam generated by a plasma gun and vapor-depositing the material; and a plasma chemical vapor deposition method (CVD method) using an organic silicon compound as a raw material in a case where a vapor deposition film of silicon oxide or silicon nitride is formed. Vapor deposition may be performed on the surface of a base material such as a support, a base material film, a wavelength conversion layer, or an organic layer.

A silicon oxide film is preferably formed by a low temperature plasma chemical vapor deposition method using an organic silicon compound as a raw material. Specific examples of the organic silicon compound include 1,1,3,3-tetramethyldisiloxane, hexamethyldisiloxane, vinyltrimethylsilane, hexamethyldisilane, methylsilane, dimethylsilane, trimethylsilane, diethylsilane, propylsilane, phenylsilane, vinyltriethoxysilane, tetramethoxysilane, phenyltrimethoxysilane, methyltriethoxysilane, and octamethylcyclotetrasiloxane. In addition, among the organic silicon compounds, tetramethoxysilane (TMOS) and hexamethyldisiloxane (HMDSO) are preferably used. This is because these compounds are excellent in handleability and vapor deposition film properties.

The thickness of the inorganic layer may be 1 nm to 500 nm and is preferably 5 nm to 300 nm, and particularly preferably 10 nm to 150 nm. By setting the thickness of the adjacent inorganic layer to be in the above range, satisfactory barrier properties can be realized and reflection in the inorganic layer can be suppressed. Thus, a laminated film having higher light transmittance can be provided.

At least one inorganic layer adjacent to the optical functional layer is preferably included in the laminated film LF. The inorganic layers are preferably in direct contact with both surfaces of the optical functional layer.

—Organic Layer—

The organic layer is a layer having an organic material as a main component and is preferably a layer including 50% by mass or more, further 80% by mass or more, and particularly 90% by mass or more of an organic material.

Regarding the organic layer, paragraphs 0020 to 0042 of JP2007-290369A and paragraphs 0074 to 0105 of JP2005-096108A can be referred to. The organic layer preferably includes a cardo polymer in a range in which the above adhesiveness condition is satisfied. Thus, adhesiveness between the organic layer and an adjacent layer, in particular, adhesiveness between the organic layer and the inorganic layer is improved, and more satisfactory barrier properties can be realized. Regarding the details of the cardo polymer, paragraphs “0085” to “0095” of JP2005-096108A can be referred to. The thickness of the organic layer is preferably in a range of 0.05 μm to 10 μm and more preferably in a range of 0.5 to 10 μm. In a case where the organic layer is formed using a wet coating method, the thickness of the organic layer is preferably in a range of 0.5 to 10 μm and more preferably in a range of 1 μm to 5 μm. In a case where the organic layer is formed using a dry coating method, the thickness of the organic layer is preferably in a range of 0.05 μm to 5 μm and more preferably in a range of 0.05 μm to 1 μm. By adjusting the thickness of the organic layer, which is formed using a wet coating method or a dry coating method, adhesiveness with the inorganic layer can be further improved.

With respect to other details of the inorganic layer and the organic layer, the descriptions of JP2007-290369A, JP2005-096108A, and US2012/0113672A1 can be referred to.

### EXAMPLES

Hereinafter, the present invention will be described in more detail with reference to examples. However, the present invention is not limited to these examples and materials, amounts to be used, proportions, treatment contents, treatment procedures and the like shown in examples below can be appropriately changed without departing from the gist of the present invention.

<<Test A>>

In Test A, the effect of the method and the apparatus for producing a functional film of the present invention on performance deterioration of a coating (functional layer) C obtained due to oxygen depending on whether or not the following configurations (A) to (D) were satisfied was investigated.

(A) The dissolved oxygen reducing device 12 is provided.

(B) The inert gas atmosphere forming device 18 is provided to form an inert gas atmosphere in the space X or Y including the coated surface from the coating start position P to the lamination start position Q on the backup roller 44.

(C) The kind of the coating device 14 is a die coater.

(D) Lamination of the film F on the coating C by the lamination device 16 is performed on the backup roller 44.

Production conditions for various test samples (example samples and comparative example samples) of functional films produced in Test A will be described.

### Example 1

(Preparation of Functional Film)

An optical functional layer forming coating solution including a quantum dot (hereinafter, referred to as a coating solution) was used as a coating solution forming an optical functional layer and gas barrier films were used as a flexible support W and a film F. In addition, for the inert gas atmosphere forming device 18, the die block type inert gas atmosphere forming device 18A was used.

<<Preparation of Flexible Support>>

A polyethylene terephthalate film (PET film, trade name: COSMOSHINE A4300, manufactured by Toyobo Co., Ltd., thickness: 50 μm, width: 1000 mm, length: 100 m) of which only one surface was undercoated with an easily adhesive layer was used.

<Formation of Organic Layer>

An organic layer was formed on the support. First, an organic layer forming coating solution was prepared. For the organic layer forming coating solution, trimethylolpropane triacrylate (TMPTA, manufactured by DAICEL-ALLNEX LTD.) and a photopolymerization initiator (ESACUREKTO46, manufactured by Lamberti S.p.A.) were prepared and weighed such that a weight ratio of TMPTA:photopolymerization initiator was 95:5, and these materials were dissolved in methyl ethyl ketone to obtain a coating solution having a concentration of solid contents of 15%.

The organic layer forming coating solution was applied to a smooth surface of the PET film, as a support, opposite to the easily adhesive surface using a roll-to-roll method with a die coater. After coating, the PET film was allowed to pass through a dry zone at 50° C. for 3 minutes and then irradiated with ultraviolet rays (cumulative irradiation dose: about 600 mJ/cm²) to be cured by ultraviolet (UV) curing. In addition, a protective film of a polyethylene film (PE film, trade name: PAC2-30-T, manufactured by Sun A. Kaken Co., Ltd.) was bonded to the support by a pass roll immediately after UV curing, then transported and rolled.

The thickness of the organic layer formed on the support was 1 μm.

<Formation of Inorganic Layer>

Next, using a roll-to-roll method CVD apparatus, an inorganic layer (silicon nitride (SiN) layer) was formed on the surface of the organic layer formed on the support. The support on which the organic layer was formed was fed by a feeding machine and was allowed to pass through a final film surface touch roll before an inorganic layer was formed, and the protective film was peeled off. Then, an inorganic layer was formed on the exposed organic layer. For the formation of the inorganic layer, as raw material gases, silane gas (flow rate: 160 sccm), ammonia gas (flow rate: 370 sccm), hydrogen gas (flow rate: 590 sccm), and nitrogen gas (flow rate: 240 sccm) were used. As a power supply, a high frequency power supply having a frequency of 13.56 MHz was used to form the SiN layer. The film forming pressure was 40 Pa, and the achieved thickness was 50 nm.

In this manner, the inorganic layer was formed on the organic layer and then the protect PE film was bonded thereto in the film surface touch roll portion after the inorganic layer was formed. Then, the inorganic layer was transported without contact with the pass roll and then rolled. In this manner, a flexible support W for applying the coating solution was prepared.

(Coating Solution Preparation Step)

<Composition of Coating Solution>

A quantum dot dispersion liquid having the following composition was prepared and used as a coating solution.
Dispersion liquid of quantum dot 1 in toluene (emission maximum: 520 nm) 10 parts by mass
Dispersion liquid of quantum dot 2 in toluene (emission maximum: 630 nm) 1 part by mass
Lauryl methacrylate 2.4 parts by mass
Trimethylolpropane triacrylate 0.54 parts by mass
Photopolymerization initiator 0.009 parts by mass

(IRGACURE 819 (registered trademark) (manufactured by Chiba Speciality Chemicals))

For the quantum dots 1 and 2, the following nanocrystals having a core-shell structure (InP/ZnS) were used.
Quantum dot 1: INP530-10 (manufactured by y NN-Labs, LLC)
Quantum dot 2: INP620-10 (manufactured by y NN-Labs, LLC)

The viscosity of the coating solution having the above composition was 50 mPa·s.

(Dissolved Oxygen Reduction Step)

The coating solution obtained in the coating solution preparation step was supplied into the tank 26 and was stirred with the stirrer 32 while supplying nitrogen gas into the tank 26, and dissolved oxygen in the coating solution was substitute by nitrogen gas such that the dissolved oxygen concentration in the coating solution was set to 1000 ppm or less. Then, the coating solution in which dissolved oxygen was reduced was supplied to the manifold 48 of the die coater 36. In addition, by substituting dissolved oxygen in the coating solution by nitrogen gas, the ratio of toluene used as a quantum dot dispersion liquid in the coating solution was set to 10000 ppm or less.

(Coating Step)

The die coater type coating device 14 was used. That is, the coating solution was discharged from the slit 50 of the die coater 36 and continuously applied to the inorganic layer of the flexible support W (from which the protective PE film was peeled off) which was transported in a state in which the support was wound around the backup roller 44. Thus, a coated film CF was formed. For the backup roller 44, a backup roller having a diameter of 200 mm was used.

(Lamination Step)

The coated surface of the coated film CF and the film F were laminated on the backup roller 44. That is, the film F which was transported in a state in which the film was wound around the lamination roller 54 was laminated on the coated surface of the coated film CF which was transported in a state in which the film was wound around the backup roller 44.

(Inert Gas Atmosphere Formation Step)

The die block type inert gas atmosphere forming device 18A was used. That is, 100 L/min/m of nitrogen gas was discharged from the slit 62 of the die block 58 to the coated surface and a nitrogen gas atmosphere was formed in the space X including the coated surface from the coating start position P to the lamination start position Q on the backup roller 44. The slit 62 having a gap of 0.5 mm was used.

(Curing Step)

The curing device 20 arranged on the arranged on the backup roller 44 was used. That is, while purging with nitrogen, the laminated film LF was irradiated with ultraviolet rays using an air cooling metal halide lamp (manufactured by EYE GRAPHICS CO., LTD.) of 160 W/cm² as the actinic ray irradiation device 56 and the coating C was cured to produce a functional film FF.

<Sheet Processing>

The formed functional film FF was punched into an A4 size sheet using a THOMSON blade having a blade edge angle of 17° and the obtained film was used as a test sample.

### Comparative Example 1

The same procedure was performed as in Example 1 except that the dissolved oxygen reducing device 12 of Example 1 was not provided, a coating solution was prepared in the air and a coating solution in which the dissolved oxygen concentration was more than 1000 ppm was fed to the coating device 14 (in a case of not satisfying configuration (A)).

### Comparative Example 2

The same procedure was performed as in Example 1 except that the inert gas atmosphere forming device 18 of Example 1 was not provided and steps from coating to lamination were performed in the air (in a case of not satisfying configuration (B)).

### Comparative Example 3

The same procedure was performed as in Example 1 except that the kind of the coating device 14 of Example 1 was changed from a die coater to a gravure coater (in a case of not satisfying configuration (C)).

### Comparative Example 4

The same procedure was performed as in Example 1 except that lamination of the film F on the coating C by the lamination device 16 was performed not on the backup roller 44 but on the pass roller subsequent to the backup roller 44 (in a case of not satisfying configuration (D)).

### Example 2

The same procedure was performed as in Example 1 except that the curing device 20 was arranged on the pass roll subsequent to the backup roller 44.

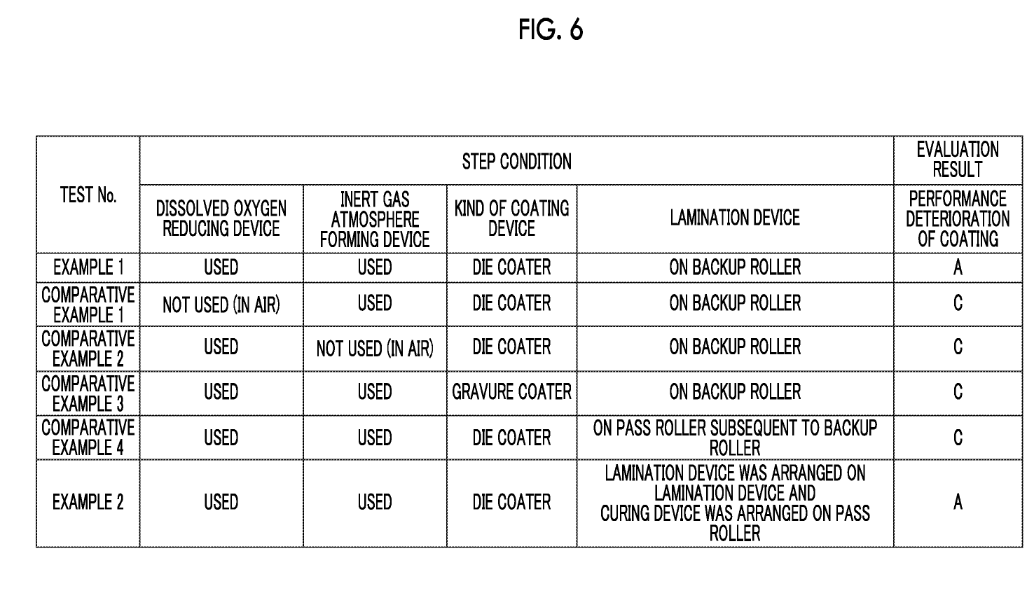

FIG. 6 is a table diagram collectively showing step conditions and evaluation results of Examples 1 and 2 and Comparative Examples 1 to 4.

[Evaluation Method of Performance Deterioration of Coating]

The brightness (cd/cm²) of samples of Examples 1 and 2 and Comparative Examples 1 to 4 prepared as described above was measured immediately after the samples were prepared (brightness immediately after preparation). Further, the brightness after the sample was put in a dry oven at 85° C. for 100 hours (brightness after oven dry) was measured. Then, performance deterioration of the coating was evaluated based on a numerical value obtained by dividing the brightness immediately after preparation by the brightness after oven dry. That is, as the numerical value obtained by dividing the brightness immediately after preparation by the brightness after oven dry increases, the performance deterioration of the coating becomes smaller. The performance deterioration was evaluated in three grades of A, B, and C. Evaluation was made such that the ranks A and B were at a pass level and the rank C was fail.
A . . . 0.95 to 1.0
B . . . 0.85 to less than 0.95
C . . . less than 0.85

[Evaluation Result]

As clearly shown in the table diagram in FIG. 6, it was found that in the functional film FF produced under the step conditions in Example 1 satisfying all of the apparatus configurations (A) to (D), the performance of the coating (optical functional layer) C including the quantum dot was evaluated as A rank.

In contrast, in Comparative Example 1 not satisfying configuration (A), Comparative Example 2 not satisfying configuration (B), Comparative Example 3 not satisfying configuration (C), and Comparative Example 4 not satisfying configuration (D) among the apparatus configurations (A) to (D), the performance of the coating (optical functional layer) C was evaluated as C rank.

In a case where one configuration among the apparatus configurations (A) to (D) was not satisfied, it was found that in the production process of the functional film, the coating (optical functional layer) C including the quantum dot was oxidized by oxygen in external air to cause performance deterioration.

The same procedure was performed as in Example 1 except that in Example 2, the lamination device 16 was arranged on the backup roller 44 and the curing device 20 was arranged on the pass roller subsequent to the backup roller 44 and as a result, the performance of the coating was evaluated as A rank.

This means that since a chance of contact with external air (oxygen in external air) is eliminated after the laminated film LF is formed by sandwiching the coating C between the flexible support W and the film F by the lamination device 16, the curing device 20 is not limited to being arranged on the backup roller 44.

However, since wrinkle generation can be prevented in a functional film FF to be produced by arranging the curing device 20 on the backup roller 44, it is preferable to arrange the curing device on the backup roller 44.

In Test A, a quantum dot was exemplified as a material whose performance was deteriorated by oxygen and a gas barrier film was used as a flexible support W and a film F. However, since deterioration easiness of performance deterioration with respect to oxygen differs depending on materials, a gas barrier film may not be used as the flexible support W and the film F in some cases.

As seen from the test results, it is possible to produce a functional film with little performance deterioration by the method and the apparatus for producing a functional film according to the present invention in a case where the film is produced with a coating solution including a material whose performance is deteriorated by oxygen and not substantially including an organic solvent.

<<Test B>>

In Test B, the relationship between the kind of the inert gas atmosphere forming device 18 and performance deterioration of the coating (functional layer) C and the relationship between the kind of the device and evenness of the coating were investigated.

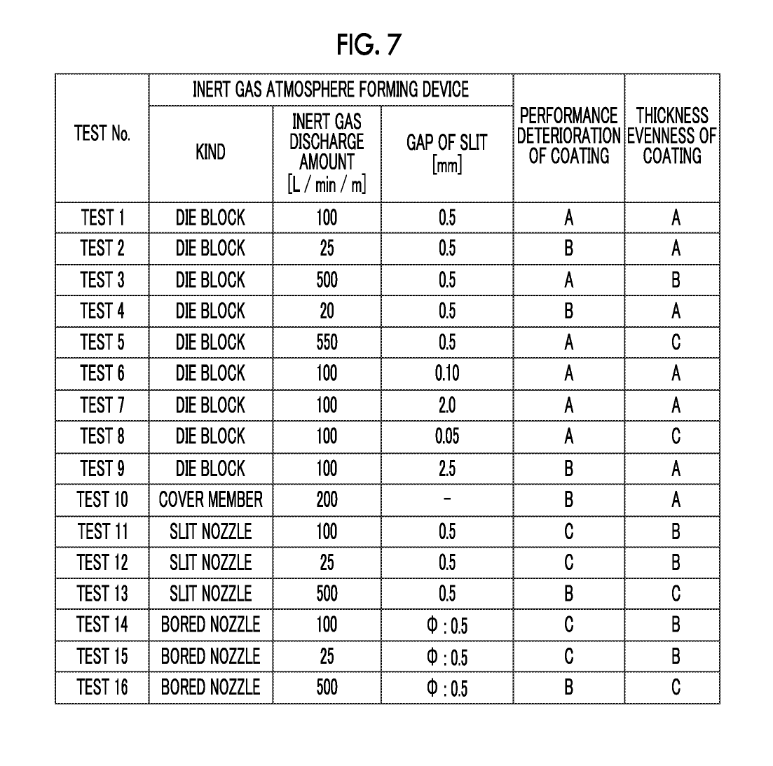

The kind of the inert gas atmosphere forming device 18 and evaluation results are shown in the table in FIG. 7.

[Test 1]

Test 1 is the same as Example 1 in Test A.

[Test 2]

Test 2 was the same as Test 1 except that the discharge amount of nitrogen gas in Test 1 was reduced from 100 L/min/m to 25 L/min/m.

[Test 3]

Test 3 was the same as Test 1 except that the discharge amount of nitrogen gas in Test 1 was increased from 100 L/min/m to 500 L/min/m.

[Test 4]

Test 4 was the same as Test 1 except that the discharge amount of nitrogen gas in Test 1 was reduced from 100 L/min/m to 20 L/min/m.

[Test 5]

Test 5 was the same as Test 1 except that the discharge amount of nitrogen gas in Test 1 was increased from 100 L/min/m to 550 L/min/m.

[Test 6]

Test 6 was the same as Test 1 except that the gap of the slit for discharging nitrogen gas in Test 1 was reduced from 0.5 mm to 0.1 mm.

[Test 7]

Test 7 was the same as Test 1 except that the gap of the slit for discharging nitrogen gas in Test 1 was increased from 0.5 mm to 2.0 mm.

[Test 8]

Test 8 was the same as Test 1 except that the gap of the slit for discharging nitrogen gas in Test 1 was reduced from 0.5 mm to 0.05 mm.

[Test 9]

Test 9 was the same as Test 1 except that the gap of the slit for discharging nitrogen gas in Test 1 was increased from 0.5 mm to 2.5 mm.

[Test 10]

Test 10 was the same as Example 1 except that the die block type inert gas atmosphere forming device 18A in Example 1 of Test A was changed to a cover member type inert gas atmosphere forming device 18B and nitrogen gas was supplied into the cover member 68 in an amount of 200 L/min/m.

[Test 11]

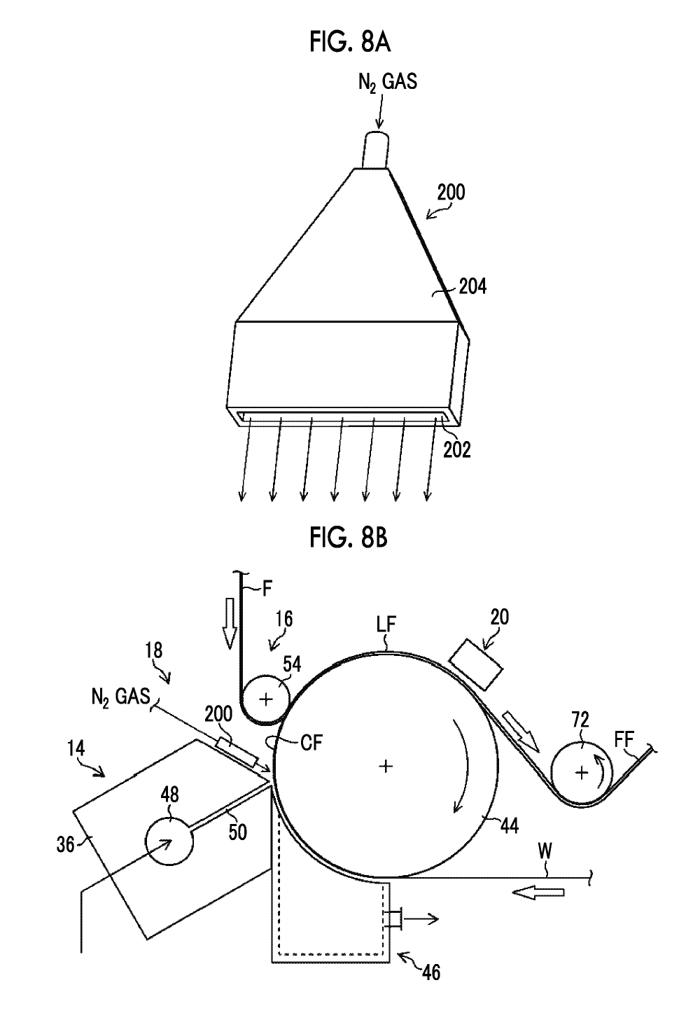

Test 11 was the same as Test 1 except that a slit nozzle shown in FIG. 8A was used as the kind of the inert gas atmosphere forming device 18 and was arranged at a position shown in FIG. 8B. As shown in FIG. 8A, a slit nozzle 200 has a thin plate-like box body 204 having a thin thickness in which a discharging port 202 long in a coating width direction was formed, and is different from the die block 58 in the present invention in that the circular arc-like distal end surface 58A opposite to the surface of the backup roller 44 is not provided. The gap of the discharging port 202 was 0.5 mm and the discharge amount of nitrogen gas was 100 L/min/m as in Test 1.

[Test 12]

Test 12 was the same as Test 11 except that the discharge amount of nitrogen gas in Test 11 was reduced from 100 L/min/m to 25 L/min/m.

[Test 13]

Test 13 was the same as Test 11 except that the discharge amount of nitrogen gas in Test 11 was increased from 100 L/min/m to 500 L/min/m.

[Test 14]

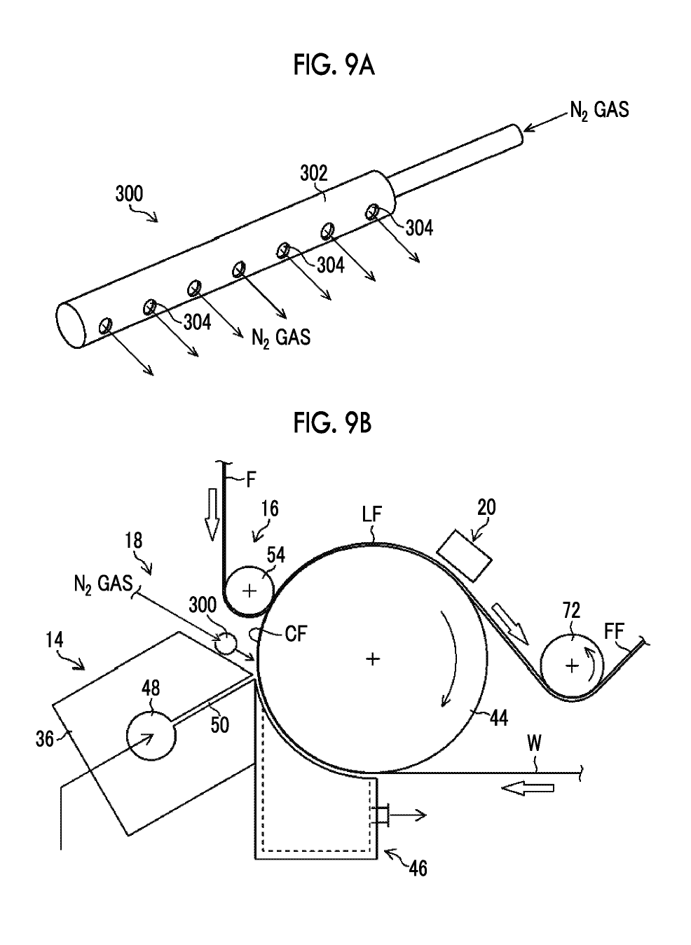

Test 14 was the same as Test 1 except that a bored nozzle shown in FIG. 9A was used as the kind of the inert gas atmosphere forming device 18 and was arranged at a position shown in FIG. 9B. As shown in FIG. 9A, a bored nozzle 300 is obtained by forming a plurality of discharge holes 304 for discharging nitrogen gas in the middle of a pipe 302 long in a coating width direction. The diameter of the discharge hole 304 was set to 0.5 mm and nitrogen gas was discharged from the plurality of discharge holes 304 in an amount of 100 L/min/m as in Test 1.

[Test 15]

Test 15 was the same as Test 14 except that the discharge amount of nitrogen gas in Test 14 was reduced from 100 L/min/m to 25 L/min/m.

[Test 16]

Test 16 was the same as Test 14 except that the discharge amount of nitrogen gas in Test 14 was increased from 100 L/min/m to 500 L/min/m.

[Evaluation Method of Thickness Evenness of Coating]

The thickness evenness of the coating was evaluated in three grades of A, B. and C by measuring a thickness distribution in the width direction of the coating (the same as the width direction of the flexible support). Evaluation was made such that the ranks A and B were at a pass level and the rank C was fail.
A . . . The thickness distribution of the coating in the width direction is within ±5%.
B . . . The thickness distribution of the coating in the width direction is within ±10%.
C . . . The thickness distribution of the coating in the width direction is more than ±10%.

[Evaluation Method of Performance Deterioration of Coating]

The evaluation method of performance deterioration of the coating is the same as in Test A.

[Evaluation Result]

As seen from the table diagram in FIG. 7, in Test 11 and Test 12 in which the slit nozzle 200 was used as the kind of the inert gas atmosphere forming device 18 and the discharge amount of nitrogen gas was set to 100 or 25 L/min/m, the thickness evenness of the coating was evaluated as B rank as a pass line but the performance deterioration of the coating was evaluated as C rank as fail. In this case, in Test 13 in which the discharge amount of nitrogen gas of the slit nozzle 200 was increased to 500 L/min/m, the performance deterioration of the coating was improved to B rank at a pass level but due to an excessive discharge amount of nitrogen gas, the coated surface was disturbed and thus the thickness evenness of the coating was evaluated as C rank of fail.

That is, it is found that the performance satisfied for the inert gas atmosphere forming device 18 in the present invention in which in a case where the slit nozzle 200 is used as the kind of the inert gas atmosphere forming device 18, an inert gas atmosphere is formed in the space including the coated surface from the coating start position P to the lamination start position Q on the backup roller 44 cannot be exhibited not to disturb the coated surface.

In addition, in Test 14 and Test 15 in which the bored nozzle 300 was used as the kind of the inert gas atmosphere forming device 18 and the discharge amount of nitrogen gas was set to 100 or 25 L/min/m, the thickness evenness of the coating was evaluated as B rank as a pass line, but the performance deterioration of the coating was evaluated as C rank of fail. In this case, in Test 16 in which the discharge amount of nitrogen gas of the bored nozzle 300 was increased to 500 L/min/m but the performance deterioration of the coating was improved to B rank of a pass level but due to an excessive discharge amount of nitrogen gas, the coated surface was disturbed and thus the thickness evenness of the coating was evaluated as C rank of fail.

That is, it is found that the performance satisfying the inert gas atmosphere forming device 18 in the present invention in which in a case where the bored nozzle 300 is used as the kind of the inert gas atmosphere forming device 18, as in the case of the slit nozzle 200, an inert gas atmosphere is formed in the space including the coated surface from the coating start position P to the lamination start position Q on the backup roller 44 can be exhibited not to disturb the coated surface.

In contrast, as shown in Test 1 to Test 9, in a case where the die block 58 was used as the kind of the inert gas atmosphere forming device 18, the performance deterioration of the all coatings was A and B ranks as a pass level.

However, in Test 5 and Test 8, it is found that the thickness evenness of the coating is C rank and in a case where the discharge amount of nitrogen gas is too excessive or the gap of the slit is too narrow, the coating is disturbed and there is an adverse effect on the thickness evenness of the coated surface.

From the above results, in a case where the die block 58 is used as the kind of the inert gas atmosphere forming device 18, in order to form an inert gas atmosphere in the space including the coated surface from the coating start position P to the lamination start position Q on the backup roller 44 without disturbing the coated surface, the die block in which the gap of the slit is in a range of 0.1 to 2.0 mm and the discharge amount of nitrogen gas is in a range of 20 to 500 L/min/m is suitably used.

In addition, in Test 10 in which the cover member 68 was used for the inert gas atmosphere forming device 18, the rank of performance deterioration of the coating was B and the rank of thickness evenness of the coating was A. The performance satisfying the inert gas atmosphere forming device 18 in the present invention in which an inert gas atmosphere was formed in the space including the coated surface from the coating start position P to the lamination start position Q on the backup roller 44 was exhibited.

### EXPLANATION OF REFERENCES

10: apparatus for producing functional film
12: dissolved oxygen reducing device
14: coating device
16: lamination device
18: inert gas atmosphere forming device
18A: die block type inert gas atmosphere forming device
18B: cover member type inert gas atmosphere forming device
20: curing device
22: nitrogen gas substituting means
24: coating solution supply means
26: tank
28: coating solution pipe
28A: opening and closing valve
30: nitrogen gas pipe
30A: opening and closing valve
32: stirrer
33: pressure reducing pipe
34: air vent pipe
36: die coater
36A: body portion
36B: distal end lip portion
36C: upstream side lip land
36D: downstream side lip land
36E: land
38: liquid feeding pipe
40: liquid feeding pump
42: nitrogen gas blowing pipe
44: backup roller
46: reduced pressure chamber
46A: side plate
46B: back plate
46C: bottom plate
46D: opening
48: manifold of die coater
50: slit of die coater
50A: discharging port
52: pipe
54: lamination roller
56: actinic ray irradiation device
58: die block
58A: distal end surface of die block 58
60: manifold of die block
62: slit of die block
62A: discharging port
64: measurement hole
66: connection pipe
68: cover member
68A: opening portion of cover member
68B: side surface of cover member
68C: lower end of side surface of cover member
70: nitrogen introducing pipe
71: measurement pipe
72: peeling roller
W: flexible support
CF: coated film
F: film to be laminated
LF: laminated film
FF: functional film
C: coating

What is claimed is:

1. A method for producing a functional film comprising:
a coating step of supplying a coating solution having a dissolved oxygen concentration of 1000 ppm or less and including 10000 ppm or less of an organic solvent to a die coater having a backup roller and applying the coating solution to a flexible support which is transported in a state in which the support is wound around the backup roller to form a coated film; and
a lamination step of laminating a coated surface of the coated film and a film on the backup roller,
wherein an inert gas atmosphere is formed in a space including the coated surface from a coating start position to a lamination start position on the backup roller.

2. The method for producing a functional film according to claim 1,
wherein the inert gas atmosphere is formed by supplying an inert gas into a cover member that covers the space.

3. The method for producing a functional film according to claim 1,
wherein the inert gas atmosphere is formed by arranging a die block, which has a distal end surface opposite to a surface of the backup roller and a slit which discharges an inert gas from the distal end surface in a width direction of the coated surface, adjacent to a downstream side of the die coater as seen from a transport direction of the flexible support and discharging the inert gas from the die block to the coated surface.

4. The method for producing a functional film according to claim 3,
wherein a gap of the slit of the die block is 0.1 to 2.0 mm and the inert gas is discharged from the slit in a discharge amount of 20 to 500 L/min/m.

5. The method for producing a functional film according to claim 1,
wherein a curing step of irradiating the coated surface with an actinic ray to cure the coated surface is performed on the backup roller after the lamination step.

6. An apparatus for producing a functional film comprising:
a coating device which has a backup roller and a die coater and applies a coating solution to a flexible support which is transported in a state in which the support is wound around the backup roller to form a coated film;
a lamination device which laminates a coated surface of the coated film and a film on the backup roller; and
an inert gas atmosphere forming device which forms an inert gas atmosphere in a space including the coated surface from a coating start position to a lamination start position on the backup roller.

7. The apparatus for producing a functional film according to claim 6,
wherein the inert gas atmosphere forming device has
a cover member which covers the space, and
an inert gas supply device for supplying an inert gas into the cover member.

8. The apparatus for producing a functional film according to claim 6,
wherein the inert gas atmosphere forming device is a die block which is disposed adjacent to a downstream side of the die coater as seen from a transport direction of the flexible support, and has a distal end surface opposite to a surface of the backup roller, and a slit which discharges an inert gas from the distal end surface in a width direction of the coated surface.

9. The apparatus for producing a functional film according to claim 8,
wherein a gap of the slit of the die block is 0.1 to 2.0 mm and the inert gas is discharged from the slit in a discharge amount of 20 to 500 L/min/m.

10. The apparatus for producing a functional film according to claim 6,
wherein a curing device which irradiates the coated surface with an actinic ray to cure the coated surface is arranged at a downstream position of the lamination device on the backup roller.
